(19) United States
(12) Patent Application Publication
(10) Pub. No.: US 2023/0405941 A1
(43) Pub. Date: Dec. 21, 2023

(54) METHOD FOR BONDING RUBBER AND ADHESIVE FOR BONDING RUBBER

(71) Applicant: HEJATEX GMBH, Straubing (DE)

(72) Inventor: Edgar JAKOB, Straubing (DE)

(73) Assignee: HEJATEX GMBH, Straubing (DE)

(21) Appl. No.: 18/201,033

(22) Filed: May 23, 2023

Related U.S. Application Data
(63) Continuation of application No. 16/636,118, filed on Feb. 3, 2020, now abandoned.

(30) Foreign Application Priority Data
Aug. 3, 2017 (DE) 102017007248.5
Aug. 3, 2018 (DE) 102018118869.2

(51) Int. Cl. B29C 65/48; B29C 65/00; C09J 175/04; B29C 65/78; C09J 11/06; B29C 65/52

(52) U.S. Cl. CPC B29C 65/485; B29C 66/02245; C09J 175/04; C09J 2409/006; C09J 11/06; B29C 65/524; B29C 66/71; B29C 65/7841

(57) ABSTRACT

The invention relates to a high-strength and permanently elastic curable adhesive for bonding at least two surfaces, of which at least one surface is a surface of a permanently elastic plastic, wherein the adhesive is an adhesive that cures in at least two different hardening mechanisms, wherein the first hardening mechanism comprises a chemical reaction to form a chemical bond including a sulphur atom, and the second hardening mechanism comprises the formation of crystalline structures from amorphous polymers. The invention also relates to a method for high-strength and permanently elastic bonding of at least two surfaces to one another, of which at least one surface is that of a permanently elastic plastic, by means of such an adhesive, said method comprising the steps of: applying the adhesive to at least a first of the surfaces to be connected, ensuring conditions under which at least the first hardening mechanism of the adhesive can take place, bringing the first surface into contact with the second surface, and ensuring conditions under which the second hardening mechanism of the adhesive can take place.

The invention relates to a method for high-strength and permanently elastic bonding of surfaces to one another, of which at least one surface is a surface of a permanently elastic plastic, by means of an adhesive. The invention further relates to a corresponding adhesive.

Cold adhesive methods for bonding rubber are known from the prior art. It is crucial that the bond is both high-strength and permanently elastic so that it does not break when the rubber is deformed.

Various adhesives are used for an adhesive connection between rubber surfaces using the cold adhesive process. Adhesives based on polychloroprene, a synthetic rubber, are often used. Polychloroprene adhesives contain chloroprene polymers dissolved in solvents and belong to the class of contact adhesives. In the case of contact adhesives, the hardening begins after application without exposure to heat by evaporation of the solvent. Only after the solvent has largely evaporated are the surfaces to be bonded brought into contact under high contact pressure, and crystalline structures are formed from the chloroprene polymers. Cohesion or adhesion within the adhesive or between the adhesive and the surfaces to be bonded is based on molecular interactions, such as van der Waals interactions, and mechanical cohesion through diffusion of polymer molecules into the surfaces to be bonded. The solvents that evaporate as the adhesive hardens represent an increasing problem. In most cases, volatile organic solvents are used, which can pose health risks for a user, such as drowsiness, nausea, headache, irritation of the mucous membrane, organ damage and cancer. Such bonding techniques are therefore ruled out, particularly when bonding in poorly ventilated surroundings, for example on conveyor belts underground. Since contact adhesives are thermoplastics, their use for bonds that require a certain level of heat resistance or a wide range of operating temperatures is restricted.

Another class of adhesives used to bond rubber surfaces to another surface are reactive adhesives. Reactive adhesives contain monomers or shorter polymer chains, which are linked to long-chain polymers by a chemical reaction and thereby harden. With regard to the chemical reaction, polyaddition mechanisms, polycondensation mechanisms, or chain polymerisation mechanisms are known, among others. A reaction can be initiated thermally, photolytically, with atmospheric oxygen, and/or air humidity or by simply mixing the components. A basic distinction is made between 1-component adhesives and 2-component adhesives in the case of reaction adhesives, with the corresponding implementation being determined by the monomers used and the type of chemical reaction. In the case of 2-component adhesives, a mixture is made before use. Cohesion and adhesion take place through chemical bonding and molecular interactions. Reactive adhesives have a pot life that depends on the chemical reaction. The reaction adhesive can be processed within the pot life; after the pot life has been exceeded, the viscosity of the mixture is so high that the surfaces to be bonded can no longer be wetted. One difficulty with 2-component adhesives is maintaining the mixing ratio and uniform mixing, which are crucial for high-strength and permanently elastic bonding. Reaction adhesives often contain volatile solvents in which the monomers or the shorter polymer chains are dissolved. These solvents evaporate during use and become a risk to the user. As already explained above with regard to the contact adhesives, such adhesives are eliminated in poorly ventilated surroundings, for example that of underground conveyor belts, due to the solvent.

Furthermore, hot methods for connecting rubber surfaces are known from the prior art, including vulcanisation. This method uses vulcanising solutions which contain, among other things, dissolved rubber mixtures, various solvents, crosslinking chemicals such as sulphur, peroxides or metal oxides, and vulcanisation accelerators such as zinc oxide, 2-mercaptobenzothiazole, or dithiocarbamates. The vulcanising solution is applied to the rubber surfaces to be bonded and pressed with a vulcanisation press at high pressure and at a high temperature for several hours. The chemical reaction of the rubber molecules with the crosslinking chemicals, in the case of sulphur with the formation of sulphur bridges, leads to the crosslinking of the rubber molecules. Vulcanisation involves the use of volatile and harmful solvents, such as trichlorethylene, and in some cases toxic vulcanisation accelerators. Vulcanisation also requires a high level of technical effort and specialist knowledge. Especially in remote and/or poorly accessible areas such as mines (especially underground), these materials and the technical equipment required, such as vulcanising presses (especially explosion-proof vulcanising presses), are often not available, so that, for example, damage to conveyor belts results in long downtimes and cannot be avoided with conventional methods.

The object of the present invention is to provide a method for high-strength and permanently elastic bonding of at least two surfaces to one another, of which at least one surface comprises rubber, by means of an adhesive, which does not have the disadvantages mentioned above or at least minimises them. Preferably, the method should be able to be carried out quickly, without great expenditure on equipment, as independently as possible from supply networks such as electricity and/or water, and in poorly ventilated areas—if possible without putting the health of the executing personnel at risk. For the latter reason, it should preferably be possible to dispense with the use of substances which are harmful to health, and it should not require great technical effort. It is also an object of the invention to provide an adhesive for the method according to the invention.

This object is achieved by a method for high-strength and permanently elastic bonding of at least two surfaces to one another, of which at least one surface is a surface of a permanently elastic plastic, according to claim 1, and by an adhesive according to claim 8.

An essential aspect of the invention is a method for high-strength and permanently elastic bonding of at least two surfaces to one another, of which at least one surface is a surface of a permanently elastic plastic, by means of an adhesive, said method comprising the steps of:
a) applying the adhesive to at least a first of the surfaces to be connected,
b) ensuring conditions under which at least a first hardening mechanism of the adhesive can take place, said mechanism comprising at least a chemical reaction with the formation of a chemical bond including at least one sulphur atom,
c) bringing the first surface provided with the adhesive into contact with the second surface optionally also provided with the adhesive,
d) ensuring conditions under which at least a second hardening mechanism of the adhesive can take place, said mechanism comprising at least the formation of crystalline structures from amorphous polymers.

High-strength bonding is understood to mean any bonding that bonds at least two surfaces, of which at least one surface is a surface of a permanently elastic plastic, and bonds the surfaces to one another in such a way that it is difficult and preferably not at all (at least not non-destruc-tively) possible to separate them from each other. As a result, the bonded surfaces can be subjected to high loads and stresses, while, at the same time, the risk is reduced of the surfaces being separated again when the force is high.

The adhesive preferably passes through a so-called B stage during step d). This stage is a particularly long processing time before the surfaces to be bonded have to be put together. In addition, a particularly high initial tack can be achieved.

Part of the adhesive preferably diffuses into at least one of the surfaces to be bonded during steps a) and/or b). This part of the adhesive more preferably diffuses up to at least 1 μm, preferably at least 10 μm further, preferably at least 50 μm, more preferably at least 100 μm, and particularly preferably between 50 and 300 μm, into one of the surfaces to be bonded.

In this context, permanent elastic bonding is understood to mean any bonding that bonds at least two surfaces, of which at least one surface is a surface of a permanently elastic plastic, and the resulting bond between the surfaces has a high degree of elasticity, that is to say deformability and extensibility. This elasticity of the bond is particularly important when bonding rubber surfaces, since rubber surfaces can deform and stretch. Since rubber is preferred as a material in areas where its deformability and stretchability are permanently used, adhesion points or bonds are also exposed to these changes in shape. Due to the high elasticity of the bond, the breaking of the bond can be prevented or reduced, and the resultant separation of the bonded surfaces can be avoided.

In a preferred variant, the permanently elastic plastic, the surface of which is bonded, comprises rubber. In connection with the present invention, the material “rubber” is to be understood in general as any form of vulcanisate of natural and/or synthetic rubbers. Insofar as the present invention is described using the example of rubber, this should nevertheless be understood as merely an exemplary embodiment and the method in general for bonding two surfaces to one another, of which at least one surface is a surface of a permanently elastic plastic. This also applies analogously to the permanently elastic adhesive, which—even if described using the example of rubber—is also generally configured for the permanently elastic bonding of two surfaces, in which case one of the surfaces to be bonded to one another is a surface of a permanently elastic plastic.

It is further conceivable that the at least one surface that is bonded to the surface of the permanently elastic plastic is also a permanently elastic plastic, is preferably rubber or comprises rubber, or consists of a material or comprises a material that is selected from a group that includes metal, glass, ceramics, wood and textile.

Through the at least two hardening mechanisms of the adhesive, in which the at least first hardening mechanism of the adhesive comprises at least one chemical reaction with the formation of a chemical bond including at least one sulphur atom, and in which the at least second hardening mechanism of the adhesive comprises at least the formation of crystalline structures from amorphous polymers, a particularly special firm bond is achieved. The chemical reaction to form a chemical bond including at least one sulphur atom during the first hardening mechanism of the adhesive is preferably carried out by the chemical reaction of a reactive group of the adhesive, which preferably comprises a sulphur atom, an oxygen atom or a (preferably C-C—) double bond, with a reactive group of the permanently elastic plastic containing at least one sulphur atom and/or a (preferably C-C—) double bond. This results in a particularly strong adhesion between boundary layers of the adhesive and the permanently elastic plastic. Particularly preferred is the formation of a sulphur-sulphur bond, a sulphur-oxygen bond, a sulphur-carbon bond, each of which enables particularly strong adhesion between boundary layers of the adhesive and the permanently elastic plastic. It would also be conceivable to form a sulphur-hydrogen bond and its adhesion (e.g. via Van der Vaals forces) with the other component of the compound.

Due to the formation of crystalline structures from amorphous polymers during the second hardening mechanism of the adhesive, polymer molecules are preferably arranged in such a way that association areas increase and attractive interactions between the polymer molecules are strengthened in this way.

In contrast to methods known from the prior art for high-strength and permanently elastic bonding of at least two surfaces to one another, of which at least one surface is a surface of a permanently elastic plastic, the method according to the invention offers the advantage that the first hardening mechanism and the second hardening mechanism of the adhesive preferably take place without high technical effort and high temperatures, such as is necessary for vulcanisation. This ensures a simple and safe application of the method. It is therefore preferably also feasible for users who are not specially trained and/or are in an inaccessible environment and/or without a power supply. Such a method thus offers significant advantages over methods for bonding rubber surfaces with significantly increased technical and material expenditure, such as vulcanisation.

Furthermore, the presence of two different hardening mechanisms according to the invention rep-resents a significant advantage over methods in which the adhesives used have only one hardening mechanism. When using, for example, contact adhesives, the bonding is based only on the formation of crystalline structures from polymers. Due to the inventive combination of the two different hardening mechanisms, the advantages of both hardening mechanisms can be used in an advantageous manner and thus a significant strengthening of the bond can be achieved.

Suitable working and/or ambient conditions for steps b) and/or d) of the method have been found to be an ambient temperature and/or material temperature between −40 and +80° C., preferably between −20 and +70° C., more preferably between −5 and +65° C., and particularly preferably between +5 and +60° C. If processing is not possible or is only possible with difficulty due to ambient conditions outside this range, it is advisable to at least temper the adhesive and the areas to be bonded up to the temperature range specified above. Processing within these temperature ranges is preferred due to the simpler handling and suitable reaction/setting times of the adhesive in most cases. Nevertheless, it has been shown that the adhesive described above can be processed in a further temperature range, namely preferably at least in the range of −40 to 120° C. The processing times should be adjusted accordingly at temperatures deviating from the preferred processing temperatures mentioned above.

Regardless of the preferred working and/or ambient temperatures mentioned above, it is further preferred that the bonding surfaces are at least largely dry, dust-free, grease-free and/or oil-free.

The adhesive described above may include other components such as solvents, primers, fillers, or combinations thereof. Solvents can be present, for example, in a proportion of up to 85 wt. % (based on the total mass of the adhesive in the uncured state). Unless a percentage is explicitly defined differently in the following, a percentage should be understood in each case as a percentage by weight based on the total mass of the adhesive in the uncured state. Solvents in the adhesive composition have the advantage that they could promote the diffusion of adhesive-ac-tive components within the adhesive. In the case of the preferred multicomponent adhesives in particular, accelerated diffusion could be advantageous.

However, studies have shown that sufficient mixing of the components and excellent adhesive properties can be achieved even without high proportions of solvent. It has, therefore, turned out to be preferred to reduce the proportion of the solvent to less than 50 wt. %, preferably less than wt. %. In a preferred composition, the adhesive comprises 10-20 solvents, preferably 10-15 solvents.

It has proven to be preferred that an adhesive with less than 5 wt. % of solvent, preferably less than 3 wt. % of solvent, more preferably less than 1 wt. % of solvent is used for the method and particularly preferably a solvent-free adhesive is used, so that a minimum time interval between steps b) and c) necessary for the evaporation of solvent is less than 1 hour, preferably less than minutes, and more preferably less than 15 minutes, at an ambient temperature between 20 and 25° C. This—and in particular the particularly preferred use of the solvent-free adhesive—can ensure that there are no risks to humans and the environment caused by volatile solvents and that the process can be carried out without extensive safety measures and in poorly ventilated places. Furthermore, in the particularly preferred use of the solvent-free adhesive, the necessary minimum time interval for the evaporation of the solvent between steps b) and c) can be minimised at an ambient temperature between 20 and 25° C., thus reducing the duration of the method, which results in a reduced working time of the user.

According to a preferred embodiment, the adhesive is a two-component adhesive, which is preferably provided in a double cartridge and is further preferably applied to the bonding surface by means of a compatible cartridge gun. The use of two-component adhesives has proven to be advantageous since the two-component adhesive only cures as soon as two components of the adhesive are mixed. Since the two components are provided separately from one another in the double cartridge and cannot react with one another, a good shelf life is achieved. In a preferred embodiment of the adhesive, its usability can thus be guaranteed over a period of at least one year, preferably over at least 18 months, and particularly preferably at least 2 years. By using the compatible cartridge gun, the two components can be applied in the intended mixing ratio (preferably in the range 10:1 to 1:3, particularly preferably 1:1, in each case based on the volume) on the surfaces to be loaded.

In one method variant, it is preferred that the adhesive is applied to the surface to be bonded in an amount of less than 500 g/m², preferably less than 300 g/m², more preferably less than 200 g/m², and particularly preferably less than 100 g/m². This ensures a high level of economy due to the small amount of adhesive that is necessary for bonding. In addition, high-strength and permanently elastic bonds with very thin gap widths can be achieved in this way.

It is preferred that at least the surface comprising the permanently elastic plastic, preferably both surfaces to be bonded, are cleaned and roughened before step a), preferably using a tool selected from a group comprising rougheners, angle grinders, (belt) planes, brushes, grinding belts, grinding wheels, milling cutters and others, whereby the production-related separating layer on the surface is also removed, and the best possible bonding can be achieved for the surface of the permanently elastic plastic. Furthermore, there is no need to pre-treat the adhesive surfaces with a chemical cleaner and/or an adhesion promoter, as is known from the prior art in the case of adhesive bonding processes. Avoiding these partially volatile substances is particularly advantageous in poorly ventilated environments such as underground.

It is preferred that at least one, preferably both, of the surfaces to be bonded when subjected to a test substance with a surface tension below 50 mN/m, preferably ≤46 mN/m, more preferably ≤38 mN/m, particularly preferably ≤30 mN/m, in particular preferably ≤20 mN/m, has a surface wetting with the test substance. The associated uniform wettability enables a sufficiently uniform wetting of the surfaces to be bonded with the adhesive and thus a homogeneous adhesive force over the entire adhesive surface.

A variant of the method is characterised in that the surfaces to be bonded are fixed and/or pressurised opposite one another by means of a suitable fixing device, preferably a pressurising device, after step d), with the pressurising device preferably having at least one pressure element, particularly preferably at least one screw clamp, and comprising at least one pressure distribution element, with the at least one pressure distribution element distributing the pressure generated by the at least one pressure element over an area that includes the bonding area. Such a preferred pressurisation device ensures precise bonding without changing the position of the surfaces and optimal adhesion, since the pressure generated is distributed uniformly over the bonding area, and sufficient contact of the surfaces to be bonded is ensured.

A preferred variant is further characterised in that the surfaces to be bonded are parts of a permanently elastic plastic belt, preferably a conveyor belt, with the surfaces to be bonded preferably being opposite ends of the permanently elastic plastic belt, which are joined to form an endless belt or are arranged on opposite sides of a damaged area, in particular a hole or tear. However, the method is not limited to the above-mentioned connection of opposite ends of a permanently elastic plastic belt or conveyor belt to an endless belt. Of course, several previously separate sections of a belt can also be joined to form a single belt. This simplifies the transport of the belt sections to the place of use, since the belt sections can be transported individually and are easier to handle due to the shorter length compared to the entire belt. In an inaccessible environment—for example underground—there is largely no need for heavy equipment for handling the belt. Rather, individual belt sections could be transported into the mine and connected there.

The high-strength and permanently elastic curable adhesive according to the invention, which is provided and set up for bonding at least two surfaces to each other, at least one surface of which is a surface of a permanently elastic plastic, is particularly characterised by the fact that it is an adhesive curing in at least two different hardening mechanisms, the first hardening mechanism comprising at least one chemical reaction to form a chemical bond including at least one sulphur atom and the second hardening mechanism comprising at least the formation of crystalline structures from amorphous polymers. Due to the combination of the properties of the formation of a chemical bond including at least one sulphur atom and the formation of crystalline structures from amorphous polymers, such an adhesive not only enables bonding to the surfaces of permanently elastic plastics, but also offers the extremely strong adhesion known from contact adhesives.

The adhesive described above preferably comprises a polyurethane component. It has surprisingly been found that such a component—particularly preferably in one embodiment as a multicomponent adhesive, preferably a two-component adhesive—brings about particularly strong connections.

Also preferred is an embodiment of the adhesive which comprises less than 5 wt. % of solvent, preferably less than 3% by weight of solvent, more preferably less than 1 wt. % of solvent and is particularly preferably solvent-free. This embodiment has proven particularly suitable for use in an environment that is difficult to supply with fresh air (e.g., underground mines). In addition, this can prevent environmentally harmful properties of the adhesive. Surprisingly, there is sufficient diffusion of the components even without a solvent, so that a sufficiently large adhesive force is formed over a large area.

The adhesive is preferably distinguished by the fact that it is set by the selection and the quanti-tative ratio of the sulphur-contributing component and the polyurethane component such that the at least two different hardening mechanisms can be initiated at an ambient temperature in the range from −50 to +80° C., preferably −30 to +70° C., more preferably −10 to +65° C., and particularly preferably 0 to +60° C. The setting for curing in this temperature range has proven to be advantageous, since in this area the surfaces of the permanently elastic plastics to be bonded are not damaged, and a rapid reaction or curing nevertheless occurs.

It is also preferred that the adhesive in the cured state has a tensile strength>6 N/mm², preferably >8 N/mm², preferably >10 N/mm², more preferably >12 N/mm², and particularly preferably >15 N/mm². This tensile strength has proven to be particularly advantageous for the connection of ends of conveyor belts, since this ensures that even a permanent tensile load does not lead to the connection point being torn.

In a preferred embodiment of the adhesive, the adhesive has a modulus of elasticity in the range from 0.2 to 40 N/mm², preferably from 0.3 to 30 N/mm² and particularly preferably from 0.4 to 20 N/mm² in the cured state. This range of the modulus of elasticity has proven to be advantageous, since in this area the necessary elasticity exists in order to be able to follow the deformation of the surfaces of the permanently elastic plastics to be bonded. This is particularly important when connecting ends of conveyor belts, since they are guided over deflection rollers and the connection point must also be able to follow the deformation occurring there without damage.

It is preferred that the adhesive in the cured state on SBR rubber has a peel strength >4 N/mm, preferably >6 N/mm, preferably >8 N/mm, more preferably >10 N/mm, and particularly preferably >12 N/mm. This peel strength has proven to be particularly advantageous when connecting ends of conveyor belts, since peeling forces can occur in conveyor belts, in particular in the region of deflecting rollers, so the connection point can also withstand the peeling forces occurring there without damage.

In a preferred embodiment, the adhesive in the cured state has a Shore A hardness in the range from 50-99 Shore, preferably 55-95 Shore, and particularly preferably 60-90 Shore (measured according to DIN EN ISO 868 or DIN ISO 7619-1). This range has proven to be advantageous because there are similar material properties as in the range of the surfaces to be bonded. The transition from the surfaces to be bonded to the bonding point is therefore preferably fluid. The Shore A hardness can be set, for example, by the degree of crosslinking in the adhesive and possible fillers.

It is preferred that the adhesive in the hardened state on metals, galvanised steels, and/or (SBR) rubber has a shear strength >4 N/mm², preferably >6 N/mm², preferably >8 N/mm², more preferably >10 N/mm², and particularly preferably >12 N/mm². This shear strength has proven to be particularly advantageous when connecting ends of conveyor belts, since shear forces can occur in conveyor belts, in particular in the region of deflecting rollers, so the connection point can also withstand the shear forces occurring there without damage.

In addition, the above-mentioned adhesive and the method described above can also be used for connecting any permanently elastic surfaces. This applies not only to belts of any kind, such as belts for round balers or other agricultural equipment and conveyor belts in the raw materials and mining industries, but also to surfaces different from belts. Another conceivable application is, for example, the bonding of a permanently elastic plastic on sensitive surfaces. For example, the surfaces to be loaded with a permanently elastic plastic can be surfaces of drums (for example as a support for the drive device for conveyor belts) or the inner surfaces of containers (for example bunkers or funnels) into which (for example, sharp-edged) bulk material is to be filled. Furthermore, it would also be conceivable to bond permanently elastic plastic (e.g. rubber), for example in the form of anti-slip mats or protective pads, to any surface on which the objects placed thereon should be prevented from slipping or the object placed on the surface should be particularly protected.

A further advantage of the method described above and of the adhesive described above for this purpose is that, after the second hardening mechanism has taken place or crystalline structures have formed in the adhesive, the connection between the first and the second surface created by the adhesive point is immediately (at least slightly) resilient. Even if—as described above—waiting times for complete curing are partially preferred, a load (preferably below the maximum load) is already possible immediately.

It is further preferred that both the method described above and the adhesive can be used for different types of conveyor belts. In particular, the surfaces to be connected can be surfaces of single-layer or multi-layer, in particular two-layer conveyor belts. In addition and independently of this, the surfaces can be surfaces of reinforced or unreinforced conveyor belts. In this regard, reinforced conveyor belts should be understood to mean conveyor belts reinforced with one or more textile elements (e.g., textile fabric) as well as conveyor belts reinforced with one or more metal elements (e.g., steel cables). In contrast to contact adhesives known from the prior art, the adhesive according to the present invention thus preferably offers the possibility that it can also be bonded to textiles, metals, e.g. steel, and other materials, and thus can bond these materials via a surface to be bonded to another surface without rubber.

The method can preferably be used both for step connections and for finger connections. Finger connections can be realised both with metal (e.g., steel cable) and textile-reinforced plastics as well as with non-reinforced plastics.

Further advantages, aims and properties of the present invention are explained on the basis of the following description of attached drawings, which show the use of a high-strength and permanently elastic adhesive as described above and a method for high-strength and permanently elastic bonding of at least two surfaces to one another, of which at least one surface is a surface of a permanently elastic plastic, by means of a an adhesive. Parts of the device for bonding and/or method steps, which in the drawings at least essentially correspond in terms of their function, can be identified with the same reference numbers, these parts and/or method steps not having to be numbered and explained in all drawings.

### THE DRAWINGS SHOW

FIG. 1: two complementary conveyor belt ends prepared for connection by means of a high-strength and permanently elastic adhesive;

FIG. 2: a plan view of a step profile of a conveyor belt end prepared for connection by means of a high-strength and permanently elastic adhesive;

FIG. 3: a side view of a possible establishment of a connection between two conveyor belt ends by means of a high-strength and permanently elastic adhesive;

FIG. 4a: a schematic representation of a method step for creating the step profile at a conveyor belt end;

FIG. 4b: a schematic representation of a method step for roughening the surface of the step profile to be bonded to a conveyor belt end;

FIG. 4c: a schematic representation of a method step for applying the adhesive to the step profile at a conveyor belt end;

FIG. 4d: a schematic representation of a method step for distributing the adhesive onto the step profile at a conveyor belt end;

FIG. 4e: a schematic representation of a method step for bonding the step profiles of two conveyor belt ends;

FIG. 4f: a schematic representation of a method step for the post-processing of an abutment gap between two conveyor belt ends;

FIG. 4g: a schematic representation of a method step for pressurisation by means of a fixing device;

FIG. 5a: a schematic representation of a method step for roughening bonding surfaces of a drum covering;

FIG. 5b: a schematic representation of a method step for applying the adhesive to a drum;

FIG. 5c: a schematic representation of a method step for applying the adhesive to the drum covering;

FIG. 5d: a schematic representation of a method step for bonding one end of the drum covering onto a drum;

FIG. 5e: a schematic representation of a method step for wrapping the drum with the drum covering;

FIG. 5f: a schematic representation of a method step for shortening overlapping drum covering ends;

FIG. 5g: a schematic representation of a method step for bonding the drum covering ends to one another;

FIG. 5h: a schematic representation of a method step for removing edges of the drum covering that protrude beyond side surfaces of the drum;

FIG. 6: a schematic cross-sectional illustration of a conveyor belt reinforced with steel cable belts;

FIG. 7a-c: schematic representations of different variants of possible connections of ends of a conveyor belt reinforced with steel cable belts;

FIG. 8a, b: schematic cross-sectional representations of connected ends or ends to be connected of a conveyor belt reinforced with steel cable belts;

FIG. 9a: a schematic representation of a method step for preparing ends to be connected of conveyor belts reinforced with steel cable belts;

FIG. 9b: a schematic representation of a further method step for preparing ends to be connected of conveyor belts reinforced with steel cable belts;

FIG. 9c: a schematic representation of a method step for forming fingers that can be connected to one another at ends to be connected of conveyor belts reinforced with steel cable belts;

FIG. 9d: a schematic representation of a method step for applying the adhesive to surfaces of the ends to be connected to one another of conveyor belts reinforced with steel cable belts;

FIG. 9e: a schematic representation of a method step for bonding fingers of ends to be connected to one another of conveyor belts reinforced with steel cable belts;

FIG. 9f: a schematic representation of a method step for applying the adhesive to interconnected fingers of conveyor belts reinforced with steel cable belts;

FIG. 9g: a schematic representation of a conveyor belt fixed for curing the adhesive and reinforced with steel cable belts;

FIG. 10a, b: schematic representations of suitable fixing devices for an even pressure distribution over the connection point;

FIG. 11a-c: schematic representations of method steps for preparing ends to be connected of conveyor belts reinforced with steel cable belts;

FIG. 11d: a schematic representation of a method step for forming a plurality of notches or furrows which are arranged between the webs each enclosing a steel cable;

FIG. 11e: a schematic representation of a method step for preparing the surfaces to be bonded;

FIG. 11f, g: schematic representations of process steps for applying the adhesive to surfaces of the ends to be connected to one another of conveyor belts reinforced with steel cable belts;

FIG. 11h: schematic representations of method steps for introducing the tensile load transmission means;

FIG. 11i: a schematic representation of a method step for applying the top layer;

FIG. 11j: a schematic representation of a method step for applying edge rails for fixing the connection point in the width direction;

FIG. 11k: a schematic representation of a conveyor belt which is fixed to cure the adhesive and reinforced with steel cable belts;

FIG. 12a: a top view of a damaged area of a conveyor belt during the bevelling of the damaged area edges in preparation for their repair;

FIG. 12b: a plan view of a damaged area of a conveyor belt during surface treatment to ensure sufficient adhesion of the adhesive;

FIG. 12c: a view of a damaged area of a conveyor belt with inserted textile reinforcement;

FIG. 12d: a view of a damaged area of a conveyor belt while the adhesive is being introduced into the damaged area;

FIG. 12e: a plan view of a repaired damaged area of a conveyor belt during the curing of the adhesive;

FIG. 12f: a plan view of a repaired damaged area of a conveyor belt during mechanical reworking;

FIG. 13: an exemplary curve for the relationship between the temperature and the recommended processing time.

FIG. 1 shows two complementary conveyor belt ends 1a, 1b prepared for connection by means of a high-strength and permanently elastic adhesive. These are arranged opposite one another in such a way that they represent a possible establishment of a connection between two conveyor belt ends 1a, 1b by means of a high-strength and permanently elastic adhesive as described above. The ends 1a, 1b of the conveyor belt 1 to be bonded can be the ends of the same conveyor belt 1 or different conveyor belts. The adhesive described above is thus suitable, for example, for connecting (rubber) conveyor belts to form an endless belt or for assembling such an endless belt 1 from several easily manageable portions of conveyor belts.

As can be seen in FIG. 1, in addition to the stepped conveyor belt ends 1a, 1b, strips 2a, 2b-here with a trapezoidal cross-section—are also provided, which can bridge a corresponding abutment gap 3a, 3b on the outer top layer 4a, 4b of the conveyor belt 1. The uppermost 5c or lowest step-forming strips 5a of the step-shaped profile are therefore designed to match this strip 2a, 2b. Likewise, a corresponding design of the opposite outer (top) layer 4a, 4b of the conveyor belt 1 is provided. As a result, the longest, strip 5a, 5b forming a step protrudes beyond the longer of the two outer top layers 4a, 4b of the conveyor belt.

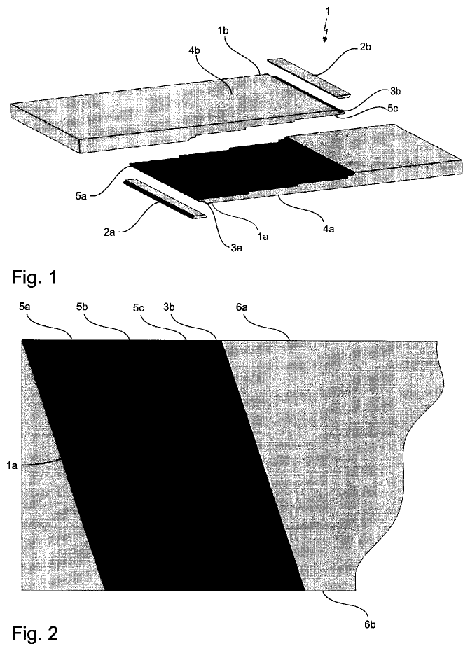

FIG. 2 shows a plan view of a step profile of a conveyor belt end 1 prepared for connection by means of a high-strength and permanently elastic adhesive. As can be seen from this top view, it is preferably provided that the steps 5a, 5b, 5c do not extend parallel to the conveyor belt end 1a, but rather run at an angle in the range >0° and <90° with respect to the latter. Because of the parallel sides 6a, 6b of the conveyor belt 1 and the step sides which do not run at an angle of 90°, each step 5a, 5b, 5c forms a trapezoidal shape. The trapezoidal configuration of the steps 5a, 5b, has the advantage that, when the connection is subjected to tensile stress, the entire contact point between two steps 5a, 5b, 5c is not simultaneously subjected to tensile stress, which could possibly favour the breaking of the connection. Rather, an edge region is first subjected to tensile stress and only then further regions of the contact point between two steps 5a, 5b, 5c. In addition, the load on the connection by other components of the conveyor system (for example transport rollers, drive means, derailleurs, wipers) can be reduced, since only parts of the connection are in contact with these components.

The individual steps 5a, 5b, 5c can each have the same width as in the example shown. However, this is not absolutely compulsory. Depending on requirements, steps 5a, 5b, 5c of different step widths could also be used. This could be advantageous, for example, if the total length of the connection is to be as short as possible. In this case, more stressed steps 5a, 5b, 5c could be made longer than less tensile-loaded ones.

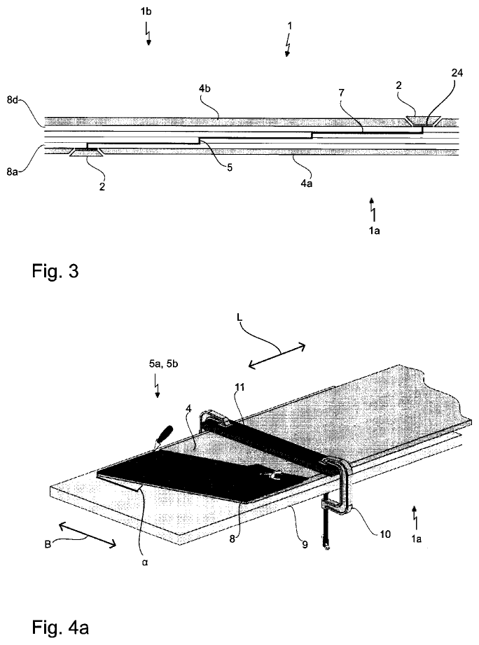

FIG. 3 shows a side view of a possible construction of a connection between two conveyor belt ends 1a, 1b by means of a high-strength and permanently elastic adhesive 7. The bonding can be seen by means of an adhesive 7 as described above between the contact surfaces of the individual steps 5a, 5b, 5c. In the example shown, a belt consists of two top layers 4a, 4b and a core divided into 4 levels or layers 8a, 8b, 8c, 8d. The 4 levels or layers 8a, 8b, 8c, 8d and the respective belt end 1a, 1b thus form 3 steps 5a, 5b, 5c. If these are joined together in a complementary manner, a core subdivided into 4 planes 8a, 8b, 8c, 8d is again formed. The length of the respective connection and the number of steps 5a, 5b, 5c can be selected, for example, in accordance with DIN 22102. The abutment gaps 3a, 3b between the two respective top layers 4a, 4b are each bridged by an abutment gap strip 2a, 2b. The latter can also be attached using the adhesive 7 described above.

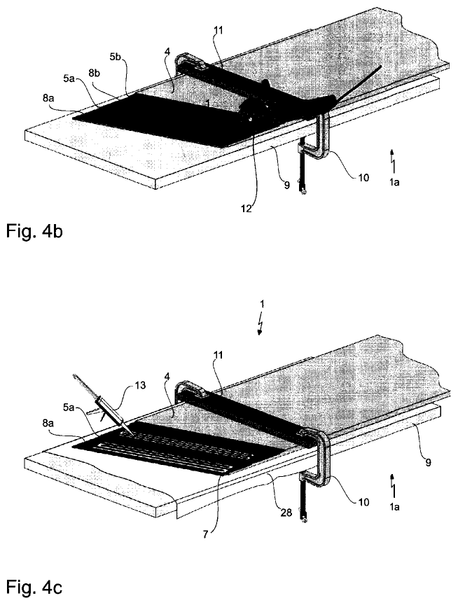

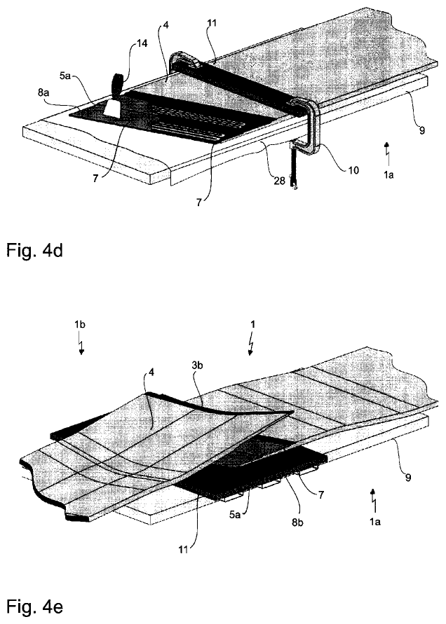

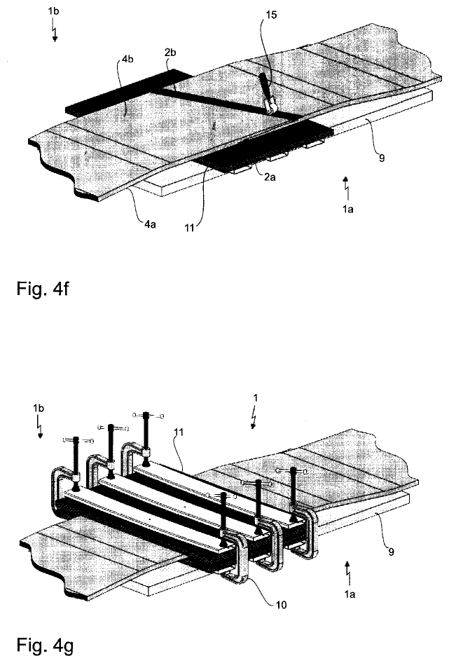

FIGS. 4a-g show individual method steps of a method for connecting conveyor belt ends 1a, 1b. FIG. 4a shows, by way of an example at the conveyor belt end 1a, that the contact point to be connected between the conveyor belt ends 1a, 1b is prepared accordingly before the bonding. In particular, it is preferred that the conveyor belt ends 1a, 1b are provided with a step-shaped profile before the bonding. The step profiles of the two conveyor belt ends 1a, 1b to be connected are designed in such a way that, when the conveyor belt ends 1a, 1b overlap, they each add up to the same thickness. Such an embodiment prevents, on the one hand, the thickness of the conveyor belt 1 from increasing undesirably in the overlap region. In addition, it is achieved that the contact area that is available for the bonding is increased. This is advantageous for the stability of the connection. As shown in FIG. 2 above, it is preferred that the steps 5a, 5b, 5c do not run perpendicular to the longitudinal direction L of the conveyor belt 1, but with respect to this direction at an angle α between, for example, 5° and 85°, preferably between 10° and 70°, particularly preferably between 15° and 55°, and particularly preferably between 15° and 45°. Such an orien-tation of the individual steps 5a, 5b, 5c, which deviates from the width direction B of the belt 1, means that on the one hand the contact area is further increased, and, on the other hand, the tensile load acting in the longitudinal direction L of the belt 1 does not act perpendicular to the abutting surface of the individual steps 5a, 5b, 5c. This further minimises the risk of the bond tearing and of damage to other system components.

As can be seen in FIG. 4a, one of the belt ends is first fixed on a suitable base 9, such as a flat workbench. This can be done, for example, by means of screw clamps 10 and optionally by means of suitable pressure distribution devices 11. Then the individual layers 8 are removed step by step to form the steps 5 described above. As was described above in connection with FIG. 2, but also shown in FIG. 4a, the respectively removed steps 5 have a trapezoidal profile. If the individual layers 8 also comprise a textile layer (not shown here), this is also removed. FIG. 4a shows how the abutting edges of the individual steps 5 are produced by inserting a cut. The individual layers 8, such as the rubber cover 4, can then be removed. If necessary, a belt slicer (not shown) must be used. The other layers are removed analogously.

The other side of the belt or the other end of the conveyor belt 1a, 1b must be prepared analogously. It should of course be noted that the angle α with respect to the longitudinal direction L of the belt 1 extends such that, in the event of an overlap, the steps 5 extend parallel and are on the opposite side, so that, if the respective ends 1a, 1b overlap, the steps 5 interlock so that the steps and the abutting surfaces of the two belt ends 1a, 1b contact each other and result in a total belt height that corresponds to the original belt height.

After these preparations, the contact surfaces are roughened, for example by means of a wire brush 12 as shown in FIG. 4b, in order to improve the adhesion of the adhesive 7 and thus also of the belt ends 1a, 1b to one another. The roughening is preferably carried out transversely to the transport direction. Then, as shown in FIG. 4c, the adhesive 7 can be applied. This can be done, for example, using a cartridge gun 13. Before doing so, however, it is advisable to check the alignment of the conveyor belt ends 1a, 1b to be connected and the dimensional accuracy of the connection, and to arrange a protective film 28 between the base or workbench 9 and the conveyor belt ends 1a, 1b to be connected, in particular in order to avoid contamination with adhesive. After bonding, the adhesive 7 described above, in contrast to contact adhesives known from the prior art, still offers the possibility of displacing the individual elements with respect to one another, and, on account of the adhesive force which already exists, and, in many cases, the handling of long and/or wide and/or heavy conveyor belts 1 which is difficult anyway, correction of the position is difficult and should be avoided if possible.

In order to achieve uniform adhesion, it is advisable, as shown in FIG. 4d, to then distribute the adhesive 7 with a spatula 14 or brush. All contact surfaces should be completely wetted, preferably down to the pores. Since the adhesive 7 starts curing immediately after application to the contact surfaces, the time from application should be measured. The longer the adhesive 7 can cure at this stage, the higher the initial adhesion that can be achieved. In the present example, optimal initial adhesion is achieved 7 to 10 minutes after application of the adhesive 7. A longer waiting time increases the initial adhesion, which may have advantages, but makes it difficult to correct the position of the belt ends 1a, 1b in the following steps.

The opposite conveyor belt end 1a, 1b (to be connected) should also be prepared.

It is advisable to also make preparations for a later fixation and pressurisation of the adhesive point after this method step at the latest. For example, as shown in FIG. 43 and the following figures, parts of a pressurisation and/or fixing device 10, 11 could now be positioned under the portion of the conveyor belt to be connected.

It would also be conceivable at this point in time to introduce the abutment gap belt 2a on the side which, for example, rests on the parts of a pressurising and/or fixing device 10, 11, since this could later be difficult to access.

After the waiting time specified for the respective adhesive 7 and the associated setting of the desired initial adhesion, the belt ends 1a, 1b are joined together as shown in FIG. 4e. In order to achieve good contact and, for example, to avoid the formation of bubbles at the contact point, it is advisable to pressurise the bond point, for example with a pressure roller 15 or a wheel, from the inside to the outside in order to expel any air bubbles to the outside. In this state, in contrast to contact adhesives known from the prior art, the position of the belt ends 1a, 1b relative to one another can be corrected, as long as the adhesive 7 is not yet too hardened.

In order to ensure as flat a surface as possible of the now connected conveyor belt ends 1a, 1b in the area of the connection point, it is advantageous, as described above, to insert a so-called abutment gap belt 2a, 2b into the top layer(s) 4a, 4b. Such an abutment gap belt 2a, 2b is preferably a rubber or PU strip with or without a textile insert. The insertion and pressing of an upper abutment gap belt 2b into the upper top layer is shown in FIG. 4f. At the latest now, if necessary, the entire connecting surface, including the abutment gap belt 2b, should be rolled on vigorously from the centre in order to drive out any air bubbles and to ensure that the bonding surfaces make sufficient contact with one another.

For the final curing, the connection point should be clamped in a corresponding fixing device 10, 11. A pressure application by means of an exemplary fixing device 10, 11 is shown in FIG. 4g. The curing time to certain (hand or handling) hardening strength is approx. 60 minutes at 23° C. in the present example. The time required depends on the composition of the adhesive and the temperature. Then the connection should be checked again. The functional strength of the connection point is reached after approximately three to four hours in the present example. After this time, the fixing device 10, 11 can be removed and the belt can be reworked if necessary. The reworking steps can include, for example, the cutting or grinding of protruding belt portions. With this method, a permanent connection of the belt ends can be achieved without the belt having to have a greater thickness in this area than in other areas. The belt 1 is ready for use after a few hours. Vulcanisation is not necessary. This means that the process can be used independently and also in places that are difficult to access. After 8 hours, for example, a conveyor belt 1 connected in this way can be used again with maximum load.

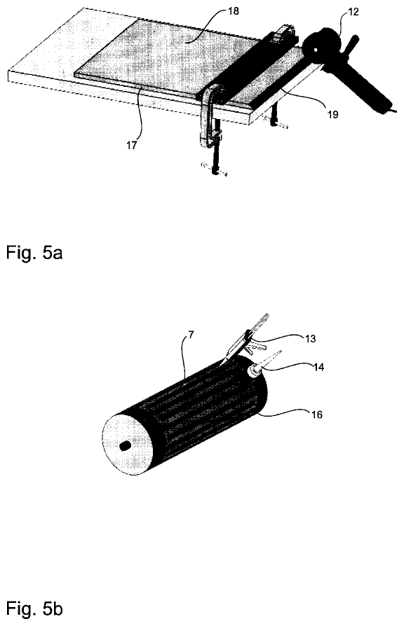

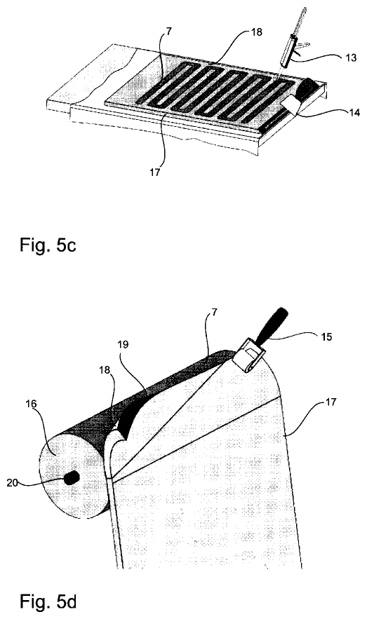

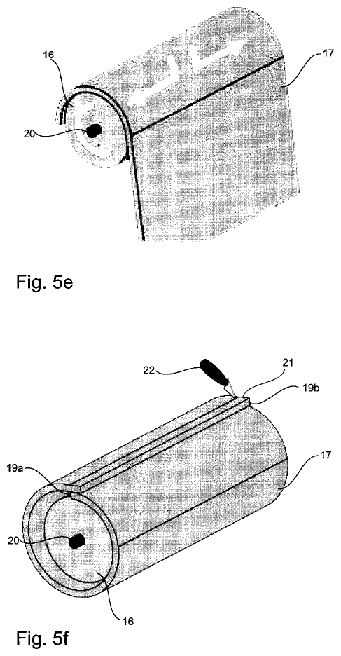

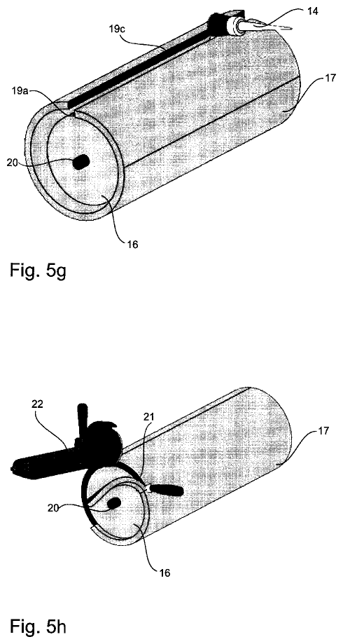

A great advantage of the adhesive 7 described above and the method for using this adhesive 7 is that the adhesive not only adheres well to rubber, but also adheres very well to other materials, including those that cannot be deformed elastically. As a result, the adhesive 7 is also suitable for covering metal drums 16 with rubber coverings 17, for example. An example of how this can be done is shown in FIGS. 5a-h. First, as shown schematically in FIG. 5a, the covering 17 provided is roughened on the bonding surfaces 18 and cut edges 19. This can be done, for example, using a roughener 12 known from the prior art or an angle grinder. In order to achieve the best possible adhesion of the adhesive 7 on the bonding surfaces 18, the bonding surfaces 18 should be cleaned before the adhesive 7 is applied. This is particularly useful for removing fats and oils, but also chips and dust that arise when roughening. This is preferably done using a broom. Solvents should be avoided. Even if this is not explicitly shown in FIG. 5a, the roughening should take place transversely to the direction of pull as far as possible in order to achieve a permanent bond.

When the covering has been prepared as described above, the adhesive 7—as shown schematically in FIG. 5b—is first applied to the surface of the drum 16 by means of a cartridge gun 13. The adhesive 7, which is initially applied in strips, is then uniformly distributed using a brush, spatula 14 or another suitable tool. It has been shown to be advantageous to use an amount of adhesive of approx. 100 to 150 g/m². This amount can be applied in one coat. A second coat is usually not necessary. Care should be taken to ensure that the entire surface of the drum 16 to be coated is completely wetted.

Since the adhesive 7 begins curing after being applied to the drum 16, it is important to record the time after the application. A long time period between application and contact with the covering 17 increases the initial adhesion between these parts 16, 17, but the correct alignment is made more difficult if the initial adhesion is too great. Therefore, immediately after applying the adhesive 7 to the drum 16, the adhesive 7 should also be applied to the inner surface 18 of the covering 17. As shown schematically in FIG. 5c, the adhesive 7 is applied to this surface 18, for example by means of a cartridge gun 13. Here, too, the adhesive 7 should be distributed uniformly using a spatula 14, brush or similar tool. The surface 18 of the covering 17 should be wetted as completely as possible.

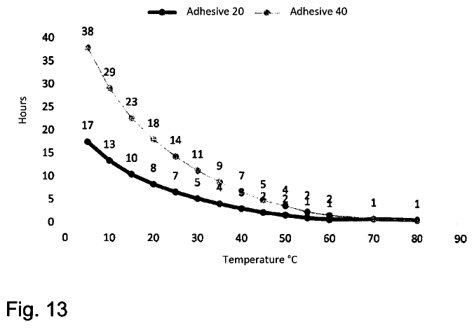

Before contacting the covering 17 with the drum 16 to be coated, the adhesive 7 should dry for a predetermined time in order to achieve the required initial adhesion. This time interval differs depending on the composition of the adhesive 7. Different time intervals can be set by different compositions of different adhesives 7, which are available for preparing the surfaces 16, 18 to be bonded. In the case of very large adhesive surfaces in particular, it is advisable to use adhesive 7 which can be processed for a longer time. With a given adhesive composition, the processing time can be controlled by changing the temperature. An exemplary curve for the relationship between the temperature and the recommended processing time is shown in FIG. 13. If such a diagram is not available for the adhesive 7 of a given composition, the most favourable time for contacting the correspondingly prepared surfaces 16, 18 can be determined using the so-called finger back method. This means that, when the back of the finger comes into contact with the surface of the adhesive, the adhesive point feels dry and, when the back of the finger is removed, no threads form between the back of the finger and the surface 16, 18 to be bonded.

If the adhesive 7 is sufficiently dry, the covering 17 is applied to the drum 16 as shown in FIG. 5d. For this purpose, the covering 17 is placed on the cutting edge 19 on the drum 16. In order to achieve the best possible bond between drum 16 and covering 17, the drum 16 should be mounted as rotatably as possible. For example, the cutting edge 19 can comparatively simply be made parallel to the longitudinal axis 20 of the drum, and the covering 17 can be gradually con-tacted with the drum surface by the rotation of the drum 16. During the application of the covering 17, it should be pressed on from inside to outside along the longitudinal axis 20 of the drum by means of a suitable roller 15. For this purpose, a roller 15 has proven to be advantageous for pressurisation.

The drum 16 is then rotated further, as shown in FIG. 5e, until the covering 17 lies completely on the drum surface. If necessary, the covering 17 could be tapped onto the drum 16 with a rubber hammer. Air pockets should be avoided and, for example, be pushed out laterally by the roller 15 described above.

In order to completely cover the drum 16 with the rubber covering 17, it is often necessary for the rubber covering 17 to be applied to be somewhat longer than the circumference of the drum 16. This ensures that one end 19a of the covering 17 overlaps with the other end 19b of the covering 17. This overlapping portion 21 is then removed, as shown in FIG. 5f. For example, it could be cut off using a knife 22 or a suitable cutter. A so-called butt joint of the ends 19a, 19b has proven to be particularly preferred, in which the connection points are made slightly obliquely inward and approx. 1 mm longer in order to cause slight pressure when closing.

As shown in FIG. 5g, the cut edge 19c that is produced is ideally roughened, and dust or abrasion is removed by means of a broom, a brush, compressed air or another suitable tool 14. Then the cutting edge 19c also has adhesive 7 applied to it. Ideally, this adhesive 7 is an adhesive 7 which differs from the previously used adhesive 7 and has a considerably shorter curing time. In this way it can be achieved that the adhesive 7 applied to the cut edge 19c which has now been introduced cures very quickly and can be adhesively bonded abutted to the opposite end 19a of the rubber belt. The covering 17 is then preferably pressed again with a roller 15 (not shown here) along the longitudinal axis 20 of the drum 16. It should be started approximately in the middle of the drum 16, and air should be pressed out towards the ends of the drum 16. If necessary, the joint 19a, 19c can be pressed on with a corrugated roller or tapped with a rubber hammer in order to achieve better adhesion.

The covering 17 should then be pressed onto the drum 16 until the adhesive 7 has completely cured. This could be done, for example, using belts (not shown). Wrapping with a stretch film has proven to be particularly suitable. After complete curing and the functional strength has been reached, projecting edges 21 should be cut off using a knife, a saw, an angle grinder or another suitable tool 22, as shown for example in FIG. 5h. The joint between the two ends 19a, 19c of the covering 17 can be equalised if necessary. For example, an angle grinder 22 could be used for this purpose.

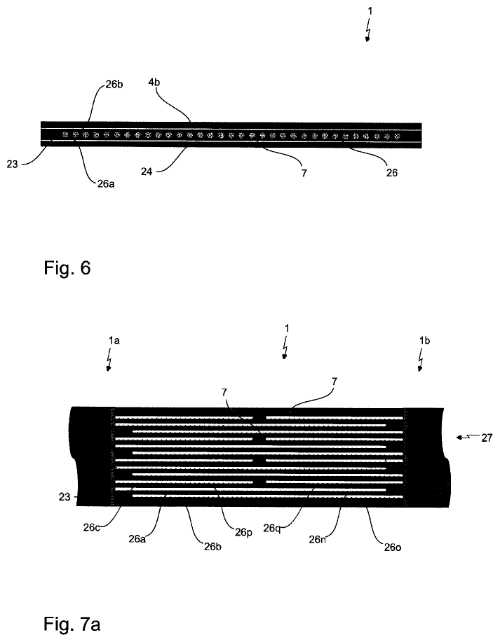

FIG. 6 shows a schematic cross-sectional representation of a connection point of a conveyor belt 1 reinforced with steel cable belts 23. Such conveyor belts 1 are often found in places where heavy loads are to be transported and/or loads are to be transported over long distances. Since the tensile loads that occur in this way can often not be removed by rubber tracks alone, rein-forcements such as steel cables 23 are usually incorporated into such conveyor belts 1. In addition, a textile reinforcement 24 can optionally be provided. However, this makes their handling difficult due to, among other things, their additional density and their greater rigidity. Therefore, in particular in the case of such conveyor belts 1, a quick and easy to implement connection of conveyor belt ends 1a, 1b without the use of heavy equipment—for example in the event of a tear—is desired.

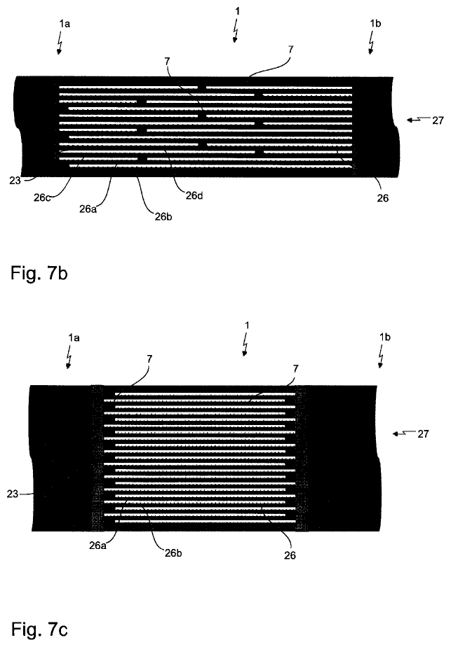

In the cross-sectional illustration of a connection point shown in FIG. 6, a multiplicity of reinforcing elements 23, here steel cable belts 23, are shown. As described below in connection with FIGS. 7a-c, these can be connected to different ends 1a, 1b of the conveyor belt 1. Usually, one of these reinforcing elements 23, together with the material 25 surrounding them, in particular the surrounding rubber material, forms a so-called finger 26a, which is bonded by the adhesive 7 described above with the neighbouring fingers 26b, 26c (which are associated with, for example, the other conveyor belt end 1a, 1b). Ways of interlocking these fingers 26a, 26b, 26c to ensure sufficient stability are shown in FIGS. 7a-c and described below:

FIGS. 7a-c show schematic representations of different variants of possible connections of ends 1a, 1b of a conveyor belt 1 reinforced with steel cable belts 23. The connection types shown differ in the overlap of neighbouring fingers 26a, 26b, 26c and in the length of individual fingers 26a, 26b, 26c.

FIG. 7a shows a 2-step belt connection. This connection is sufficiently stable and flexible for most connections. In this type of connection, three different types of fingers 26a, 26b, 26c are bonded together. The three different finger types 26a, 26b, 26c are a finger 26n of full finger length (L_{s1/1}) starting from the first conveyor belt end 1a, a finger 26o of full finger length (L_{s1/1}) starting from the second conveyor belt end 1b, and a finger 26p, 26q of half the finger length (L_{s1/2}) starting from the first or second conveyor belt end. It is provided that a finger 26n of full finger length, starting from the first conveyor belt end 1a at the second conveyor belt end 1b, is opposite a gap between two fingers 26o, 26q. Correspondingly, starting from the second conveyor belt end 1b, a finger 26o of full finger length is located opposite a gap at the first conveyor belt end 1a. Fingers 26p, 26q of half the finger length also lie opposite a finger 26p, 26q of half the finger length on the opposite conveyor belt end 1a, 1b. Combinations of fingers 26p, 26q or fingers 26n, 26o and gaps that result in a full finger length (L_{s1/1}) are referred to as a pair of fingers 27. With each pair of fingers 27, it is thus ensured that the sum of the finger lengths (Lₛₙ) lying opposite each other from the two conveyor belt ends 1a, 1b results in a full finger length (L_{s1/1}).

The arrangement of these fingers 26 or finger pairs 27 in the two-stage connection can be, for example, that shown in FIG. 7a. A finger 26n of full finger length starting from the first conveyor belt end 1a is followed by a finger 26o of full finger length starting from the second conveyor belt end 1b and this is followed by a combination of two fingers 26p, 26q of half the finger length starting from both conveyor belt ends 1a, 1b. Each sequence of these three pairs of fingers 27 is followed by an identical triple of these pairs of fingers 27.

Alternatively, it is conceivable that each pair of fingers 27 with a finger 26n, 26o of full finger length is followed by a pair of fingers 27 consisting of fingers 26p, 26q of half the finger length. An identical quartet of finger pairs 27 would thus follow each quartet of finger pairs 27.

An exemplary three-step belt connection is shown in FIG. 7b. As with the two-step connection described above, each pair of fingers 27 here also consists of a combination of fingers 26 or fingers 26 and gaps which result in a full finger length (L_{s1/1}). However, the three-step belt connection provides that not all fingers 26 that do not have a full finger length (L_{s1/1}) have to have exactly half the finger length (L_{s1/2}). Rather, it is provided that in addition to fingers of full finger length (L_{s1/1}) and fingers of half the finger length (L_{s1/1}) there are also fingers of other lengths, for example ⅓-finger length (L_{s1/3}) and ⅔-finger length (L_{s2/3}).

The arrangement of the finger pairs 27 next to each other—that is, in the width direction of the conveyor belt 1—can vary depending on the requirements. The embodiment shown in FIG. 7b is only one possible example. In contrast to the illustration shown, it is in fact also possible, for example, that fingers 26 of full finger length can extend from both conveyor belt ends 1a, 1b (only fingers of full finger length starting from the right conveyor belt end are shown in FIG. 7b). The possible variation of the contact point between fingers 26 of a finger pair 27 in this type of connection makes it possible to space the weak points of such a connection as far apart as possible in the width direction of the belt 1. While in the embodiment shown in FIG. 7a an interruption is repeated after every third finger 26, in the embodiment shown in FIG. 7b, the distance is already four fingers 26. With the above-described variant of the fingers 26n of full finger length also ex-tending from the other conveyor belt end 1a, an interruption after a sequence of five fingers 26 in the width direction could be repeated in the three-step belt connection.

The single-step belt connection shown in FIG. 7c offers a particularly simple connection that often already has the necessary connection strength. In this variant, fingers 26 of full finger length alternate, starting from the opposite conveyor belt ends 1a, 1b. In this variant, there is, therefore, a repeat of an interruption in every second finger 26 in the width direction. However, in most cases such a connection is already sufficiently stable.

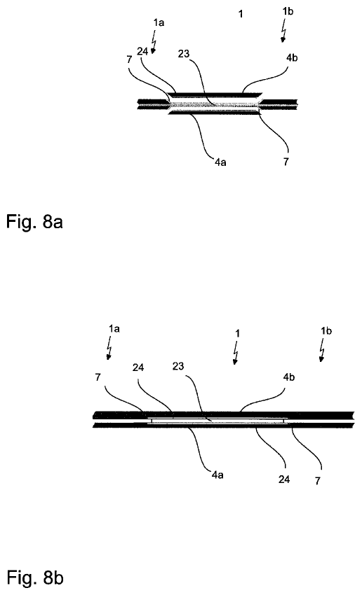

FIGS. 8a and b show schematic cross-sectional representations of ends 1a, 1b of a conveyor belt 1 which are connected or are to be connected reinforced with steel cable belts 23. While the core, which is formed by the fingers 26 comprising the steel cables 23, has already been bonded in FIG. 8a, this figure shows how the top layer 4a, 4b is applied. This can be done with or without a textile reinforcement 24. So that the top layer 4a, 4b can be inserted as precisely as possible into the connection point, the ends of the connection point are chamfered, preferably running from the outside inwards. This also enables simplified handling. The top layer 4a, 4b in the area of the connection point can be applied to the core analogously to the abutment gap strip 2a, 2b described in connection with FIG. 4f. A textile reinforcement 24 (on one or both sides) can optionally be arranged between the core and the top layer 4a, 4b. The finished connection between the conveyor belt ends 1a, 1b with an applied top layer 4a, 4b and textile reinforcement 24 is shown in FIG. 8b.

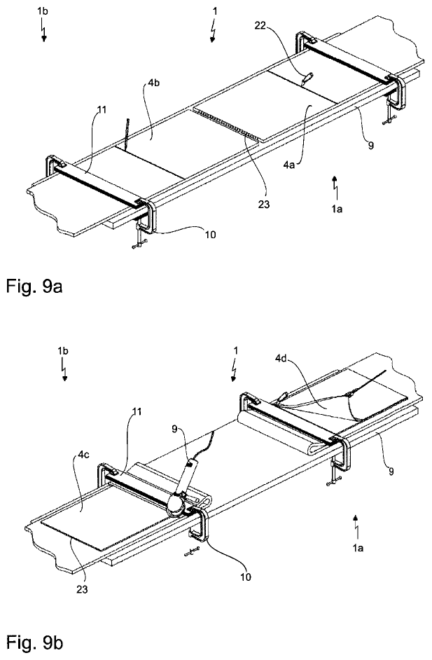

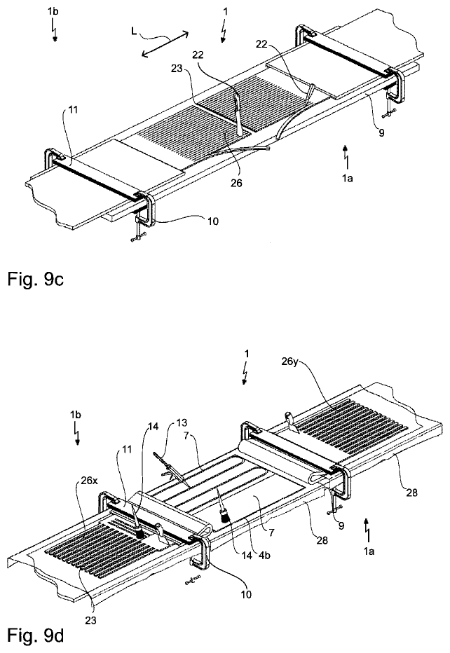

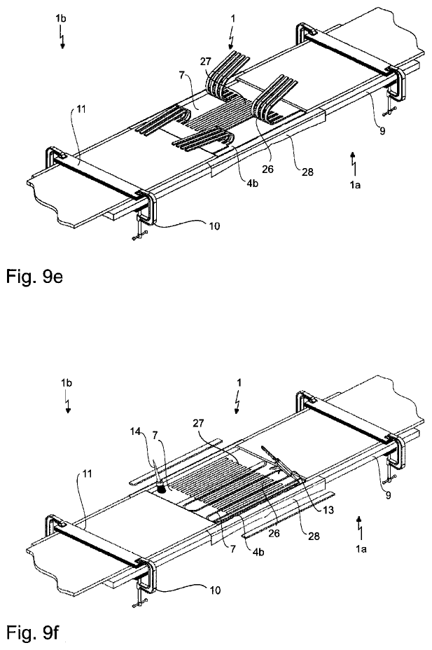

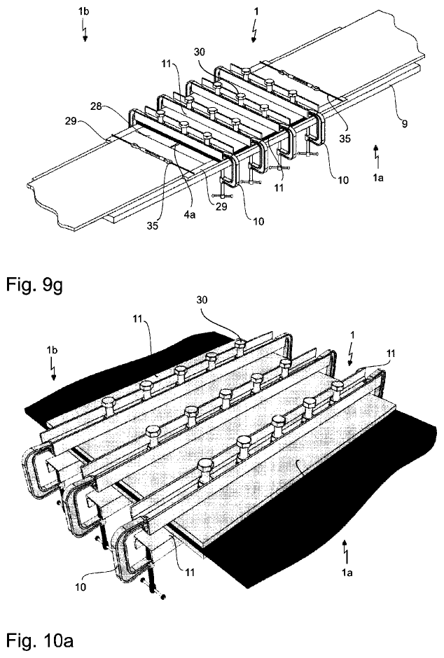

FIGS. 9a-9g schematically illustrate an exemplary method for connecting two conveyor belt ends 1a, 1b of conveyor belts 1 reinforced with steel cable belts 23. FIG. 9a shows a schematic representation of a method step for preparing ends 1a, 1b to be connected to conveyor belts reinforced with steel cable belts 23. For this purpose, the belt ends 1a, 1b to be connected are first fixed and, for example, placed on a lower fixing device or flat workbench 9 and fixed, for example, with squared timbers and/or belt tensioners or other suitable tools 10, 11. A sufficient distance should be maintained to be able to turn both sides of the belt. The belt should then be shortened to form a straight abutment edge. The abutment edge is preferably aligned at an angle of 90° to the longitudinal direction of the belt. However, other angles are also possible and (as described above with regard to belts not reinforced with steel cables) could result in a more favourable distribution of the tensile load on the connection point. Starting from the belt end 1a, 1b, the desired connection length is now marked. The connection length could, for example, be selected based on DIN 22131 or ISO 15236 Part 4. The connection length and possibly the angle (90° or different in the case of a trapezoidal connection (see above)) are marked on the belt cover 4. The belt cover 4 is then carefully cut using a suitable tool, for example a knife or cutter 22. It should be noted here that the core containing the steel cables 23 is not cut, if possible, in order to maintain the strongest possible connection of the fingers 26 (not shown) with the remaining end of the belt 1a, 1b.

FIG. 9b shows a schematic representation of a further method step for preparing ends 1a, 1b to be connected of conveyor belts 1 reinforced with steel cable belts 23. In the example shown, the belt edges 6a, 6b (arranged laterally with respect to the longitudinal direction of the belt) have been cut off in the region of the connection. This is not mandatory. However, since these areas usually do not contain any reinforcement straps 23, they are not necessary for the (re)construction of the core in the region of the connection and could interfere in the following method steps. Therefore, removal is recommended. The top layers 4c, 4d are then removed from the marked belt ends 1a, 1b. In FIG. 9b, only the removal of one top layer 4a, 4b per belt end 1a, 1b is shown, but the opposite top layer 4c, 4d must also be removed in each case. That the top layer 4a, 4b is also removed on the side not shown in FIG. 9b can be seen, for example, in FIG. 9c. The edges at the transition to the untreated conveyor belt section that arise when the top layer 4a, 4b, 4c, 4d is removed are then ground off at a flat angle of, for example, 5°-45°, preferably 10°-35°, and particularly preferably 20°-30°. Such a slope later enables the top layer 4a, 4b, 4c, 4d to adhere well even in this region, since a comparatively large overlap of newly applied top layer 4a, 4b, 4c, 4d and the existing conveyor belt section can be achieved.

Because of the weight that usually occurs with such conveyor belts 1, the use of mechanical aids such as a crane or a cable winch is recommended. Furthermore, the use of a knife and/or an electrical (or in a critical environment—for example, underground—a pneumatic) belt slicer 22 is recommended.

FIG. 9c shows a schematic illustration of a method step for forming fingers 26 which can be connected to one another at ends 1a, 1b to be connected, of conveyor belts 1 reinforced with steel cable belts 23. For this purpose, the exposed cores of both conveyor belt ends 1a, 1b are cut in the longitudinal direction L of the conveyor belt 1. The cutting is preferably carried out by means of a knife, a saw, a cutter or another suitable tool 22. Tests have shown that cuts perpendicular to the surface of the conveyor belt (more precisely along a plane that extends along the direction of transport perpendicular to the width direction of the conveyor belt) are not only particularly easy to implement, but also enable particularly permanent bonding of the fingers 26. Hexagonal or octagonal cross-sections of fingers 26 have been found to be less preferred. All longitudinal cuts are preferably at the same distance from each adjacent longitudinal cut.

After the formation of the fingers 26, individual fingers 26x₍₂ₙ₋₁), 26y₍₂ₙ₎ are removed or shortened in order to form finger pairs 27, which each have the full length of a finger 26. If, as described above, all longitudinal cuts have been made at the same distance from each adjacent longitudinal cut, all fingers 26 have the same width, so that they can mesh particularly well and lie closely against one another.

First of all, however, it is preferred that the fingers 26 now formed are turned back onto the remaining part of the respective conveyor belt 1 and the lower top layer 4b is positioned in the place of the connection. For this purpose, it is advisable to first place a protective layer 28, for example a glass fibre-reinforced PTFE film or silicone film, on the fixing device, on which the top layer is then positioned. The protective layer is preferably slightly longer and wider than the planned connection. An overlap on at least two opposite sides, preferably on all four sides, of approximately 10-30 cm, preferably approximately 20 cm, has proven to be preferred. If the protective layer 28 is larger than the planned connection point, the lower top layer 4b can still be moved on this protective layer and positioned exactly so that the fingers 26 or finger pairs 27 can later be arranged and bonded to it. In addition to the use of the protective layer 28 described below for fixing the connection point in the width direction of the conveyor belt, the protective layer 28 serves in particular to prevent the adhesive 7 from sticking to the fixing device 10, 11.

The top layer 4b, which preferably has protrusions for an overlap with the remaining conveyor belt sections, is now placed on the protective layer 28 and aligned so that the fingers 26 can be arranged and bonded to it. If desired, a textile reinforcement 24 is placed on the side of the top layer 4b facing away from the protective layer 28 (i.e. later, facing the fingers). If a textile reinforcement 24 is provided, it is preferably so elastic that it does not additionally stiffen the conveyor belt 1, so that the belt 1 can be deflected around narrow radii and the minimum drum diameter can thus be maintained.

To prepare for bonding, all contact surfaces should be roughened on all sides. The use of a roughening round brush or a metal round brush is recommended. The rubber sheets provided as top layers 4 (with the optional textile reinforcement 24) should also preferably be roughened. The resulting dust should be removed with a clean brush, compressed air or another suitable tool 22. Chemical cleaners and solvents are not recommended. After cleaning the surfaces, all surfaces should be protected from new soiling.

Subsequently, as shown in FIG. 9d, the adhesive 7 can be applied to the surfaces of the ends 1a, 1b to be connected to one another of conveyor belts 1 reinforced with steel cable belts 23. For this purpose, the adhesive 7 is applied as quickly as possible to all contact surfaces and then evenly distributed using a suitable tool, for example a spatula or brush 14. A brush 14 is particularly useful, since the adhesive 7 should also be rubbed into the pores. Adhesive 7 must also be applied to the side surfaces of fingers 26 in order to ensure a permanent connection between adjacent fingers 26. As mentioned above, the adhesive 7 should be applied as quickly as possible.

Since, with such a connection, the entire surface to have adhesive 7 applied to it is very large, and the adhesive 7 in the static mixer 13 already begins to cure after a very short time, a sufficient adhesion to the exposed surfaces can only be guaranteed with a complete application within half of the pot life specified for the respective adhesive 7. The amount of adhesive required depends in particular on the size of the gaps between adjacent fingers 26. However, at least an amount of 1,000 g/m² should be used. After the adhesive 7 has been applied completely, the time must be recorded. Due to the complexity of the finger connection described, a large part of the time during which the adhesive 7 can be processed usually passes with the application and distribution of the adhesive 7. Longer processing times would increase the initial adhesion, but the maximum processing time must not be exceeded.

FIG. 9e schematically shows a method step for bonding fingers 26 of ends 1a, 1b to be connected to one another of conveyor belts 1 reinforced with steel cable belts 23. For this purpose, the fingers 26 of both belt sides 1a, 1b are preferably folded back starting with the inner fingers (that is, the fingers furthest from the belt broadsides), so that they come to rest on the prepared top layer 4b. In the case of fingers 26 with a rectangular cross-section, they can be bonded directly to one another. In the case of fingers 26 with a hexagonal cut or gaps between adjacent fingers, filler material must be introduced between the fingers and significantly more adhesive must be used.

If the fingers 26 are fixed on a (first) top layer 4b as described above, adhesive 7 is applied, as shown in FIG. 9f, to interconnected fingers 26 of conveyor belts 1 reinforced with steel cable belts 23, in order to apply a second top layer 4a on the side of the interconnected fingers 26 opposite the first top layer 4b. For this purpose, the adhesive 7 (preferably in an amount in the range of 200-2000 g/m², preferably in the range of 300-1000 g/m², depending on the weave density of the textile fabric and the distance between adjacent fingers 26) is preferably applied with a cartridge gun 13 to the surface and in all gaps. Then it should be spread with a suitable tool 14, for example a brush or spatula, and preferably also rubbed into pores (for example with a short-bristled brush). The adhesive 7 should be applied with a slight excess between the fingers and in the gaps and evenly distributed.

The surface of the second top layer 4a to be connected with the fingers should also be have the adhesive 7 applied to it, preferably also by means of a cartridge gun 13. Overlap areas provided for connection to the existing top layer 4c, 4d of the conveyor belt sections adjoining the connection point should also have adhesive 7 applied to them. The adhesive 7 is preferably distributed evenly over the surface to which it is to be applied with a suitable tool 14, preferably a spatula or brush, and (preferably with a short-bristled brush) is also rubbed into the pores. The top layer 4a, 4b preferably has an amount of adhesive applied to it in the range of approximately 100-800 g/m², preferably 150-600 g/m², and particularly preferably 200-400 g/m². The amount of adhesive required depends in particular on the roughness of the surfaces to be bonded and the weave density of the textile fabric 24.

As is also shown in FIG. 9f, it is provided that the adhesive 7 is also applied to the outer regions of the first top layer 4b. This is necessary in order to be able to fix the outer edges of the conveyor belt 1 or—if these have been removed beforehand—new outer edges of the conveyor belt 1.

After the outer edges have been bonded, the second top layer 4a can be placed on the finger connection provided with adhesive. The top layer 4a should be pressed lightly. A roller 15 for pressing has proven to be particularly preferred, since it can be used to expel air pockets and at the same time achieve a high contact pressure.

Subsequently, it is advisable to fold the protrusion of the protective layer 28 around the connection point described above. This means that the connection point can also be protected from the side. In the case of wide conveyor belts 1, an intermediate space remaining between the folded ends of the protective layer 28 can be covered by applying a further protective layer. The folded protective layer makes it possible in particular to protect the lateral edges and thus to apply edge rails 29 during the fixing. As a result, the fingers 26 (which can no longer be seen in FIG. 9g) can also be pressurised in the width direction of the conveyor belt 1. The edge rails 29 should have a somewhat lower height than the conveyor belt 1 in order not to impair the pressurisation of the connection point. A difference in height of 0.5-1.5 mm, preferably approximately 0.8-1.2 mm, and particularly preferably 0.9-1.1 mm has proven to be particularly suitable, since this also means that application of extensive pressure in the height direction of the conveyor belt is possible.

FIG. 9g shows a schematic illustration of a conveyor belt 1 which is fixed to cure the adhesive 7 and reinforced with steel cable belts 23. The edge rails 29 are pressurised in the direction of one another by suitable means 35 (in this case length-adjustable steel cables, but chains for example with tensioning screws would also be conceivable). This also ensures that the fingers 26 are pressurised towards one another or in the width direction of the conveyor belt 1. In particular, in combination with the pressurisation in the vertical direction of the conveyor belt 1 and the associated deformation of the (rubber) elements arranged in the pressurised area in the width direction of the conveyor belt 1, an adequate pressurisation of the adhesive points in the width direction of the conveyor belt is ensured.

The connection point is also pressurised in the vertical direction. For this purpose, an upper pressure distribution device 11 (here a (possibly pre-stressed) plate) is provided, which is pressurised in the height direction of the conveyor belt by means of suitable pressurising means 10 (here, for example, screw clamps) compared to a lower pressure distribution device, namely the above-mentioned part of the fixing device. The fixing device should thus not only fix the belt and the connection point for the duration of the curing of the adhesive 7, but also exert sufficient pressure on the connection point. A pressure in the range of 10-50 N/cm², preferably in the range of 15-30 N/cm², particularly preferably of approximately 20 N/cm², has proven to be suitable for steel cable belts. This pressure ensures that sufficient adhesive 7 is also pressed between the fingers 26 and, if appropriate, into the textile fabric 24. As an alternative to the fixing device 10, 11 shown, a vulcanising press could also be used if available, whereby the curing could also be accelerated with appropriate tempering.

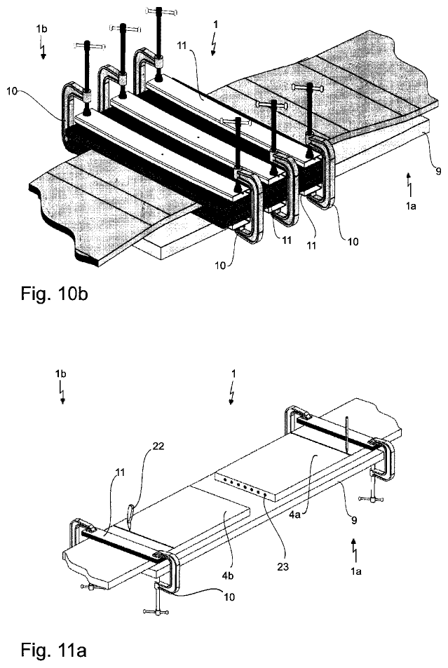

FIGS. 10a and 10b schematically show suitable fixing devices 10, 11 for an even pressure distribution over the connection point.

In FIG. 10a, U profiles 10a are used for the uniform application of pressure, the pressure being able to be adapted locally if necessary and/or the deflection of the profiles 10a being able be compensated by means of adjusting screws 30. The U-profiles 10 are arranged on opposite sides of the adhesive connection and preferably pressurise a further pressure distribution device 10b there, and are pressurised towards one another by screw clamps 11 or other suitable tools 11.

FIG. 10b shows an alternative in which pre-bent hollow profiles 10a are used to apply pressure to other pressure distribution devices 10b—for example composite panels—evenly over a large area. The pre-bent hollow profiles are arranged on opposite sides of the adhesive connection and are pressurised towards one another by screw clamps 11 or other suitable tools 11.

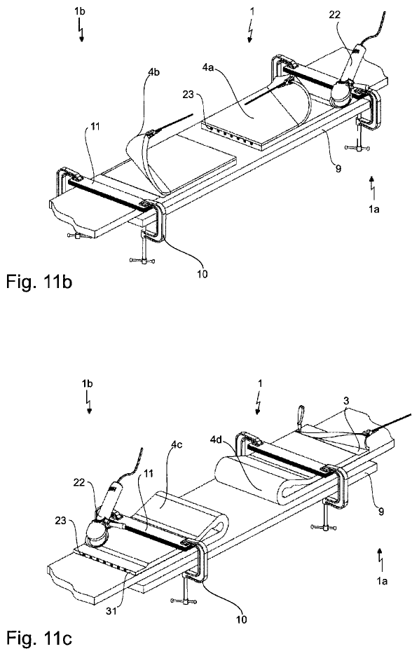

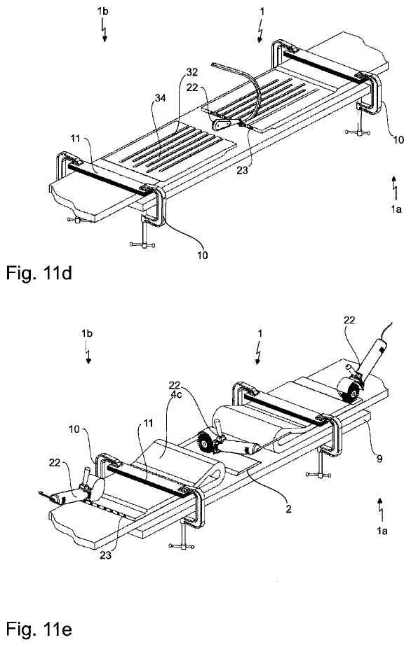

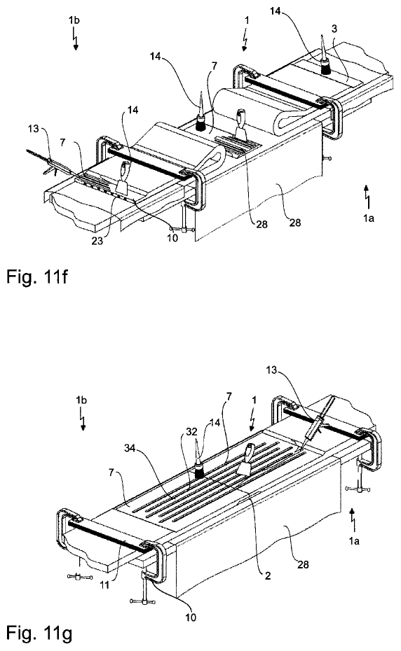

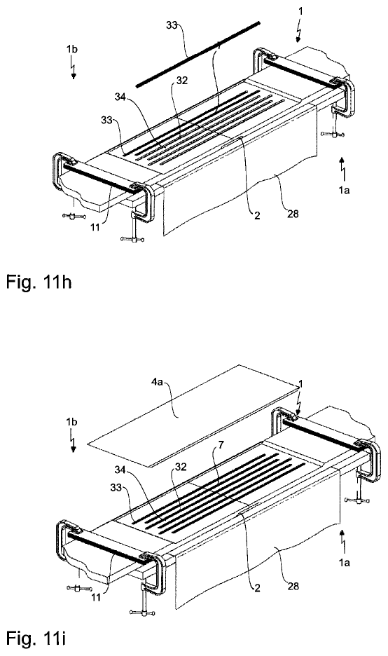

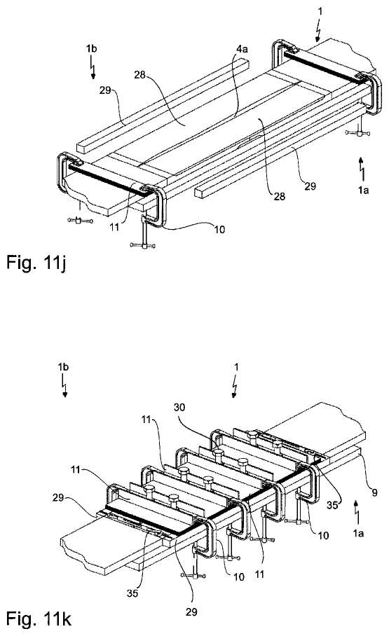

FIGS. 11a-k show a schematic representation of a further alternative for connecting ends 1a, 1b with steel cable belts 23 of reinforced conveyor belts 1. This alternative is significantly simpler in particular in the preparation of the connection point than the variant described above according to FIGS. 9a-g. In this alternative, the formation of separate fingers is not necessary, but, after the formation of a common abutting edge 31 on the conveyor belt ends 1a, 1b to be connected, only indentations 32 running parallel to these are created in the additional tensile load transmission means 33, for example, between the steel cables 23 contained therein, which are inserted in such a way that they bridge the abutment edge 31 of the conveyor belt ends 1a, 1b to be connected. The overlap region of the steel cables 23 already contained and the newly inserted tensile load transmission means 33 should be selected such that the connection point has a length analogous to DIN 22131 or ISO 15236 part 4.

FIG. 11a shows a schematic representation of a method step for preparing ends 1a, 1b to be connected of conveyor belts reinforced with steel cable belts 23. For this purpose, the belt ends 1a, 1b to be connected are first fixed and, for example, placed on a lower fixing device or flat workbench 9 and fixed, for example, with squared timbers and/or belt tensioners or other suitable tools 10, 11. As has already been described above for the method described in connection with FIGS. 9a-9g, a sufficiently large distance should be maintained in order to be able to turn over both belt ends 1a, 1b. The belt 1 should then be shortened to form a straight abutment edge 31. This abutment edge 31 is preferably aligned at an angle of 90° to the longitudinal direction of the belt. However, other angles are also possible and (as described above with regard to belts not reinforced with steel cables) could result in a more favourable distribution of the tensile load on the connection point. Starting from the belt end 1a, 1b, the desired connection length is now marked. The connection length could, for example, be selected based on DIN 22131 or ISO 15236 Part 4. The connection length and possibly the angle (90° or different in the case of a trapezoidal connection (see above)) are marked on the belt covering 4. The belt covering 4 is then carefully cut with a suitable tool, for example a knife or cutter 22. It should be noted here that the core containing the steel cables 23 is not cut, if possible, in order to maintain the strongest possible connection between the connection point and the remaining belt ends 1a, 1b.

FIG. 11b shows a schematic representation of a further method step for preparing ends 1a, 1b to be connected of conveyor belts 1 reinforced with steel cable belts 23. In contrast to the method described above, it is not necessary or preferred that the belt edges 6a, 6b (arranged laterally with respect to the longitudinal direction of the band) are separated in the region of the connection. The top layers 4c, 4d are removed from the marked belt ends 1a, 1b. As is shown and described in particular in connection with FIG. 11c, it is not necessary to pull off the opposite top layers 4a, 4b over the entire length of the connection, since no separate fingers are intended to be exposed. However, it is advisable to apply, at least in the region of the abutting edge 31, a part of the opposite top layers 4a, 4b in order to form an abutment gap 3 which can be bridged with an abutment gap strip 2. This protects the abutment edge 31 from mechanical stress and thus helps to prevent breakage at the connection point when using the conveyor belt 1. The edges of the abutment gap 3 are then ground at a flat angle of, for example, 5° to 45°, preferably 10° to particularly preferably 20° to 30°. Such an incline later enables good adhesion of the abutment gap strip 2 in this region too, since a comparatively large overlap and thus adhesion of the newly applied abutment gap strip 2 and the original conveyor belt section can be achieved. As already mentioned above, the use of mechanical aids such as a crane or a cable winch is also recommended here due to the weight that usually occurs in such conveyor belts 1. Furthermore, the use of a knife and/or an electrical (or in a critical environment—for example, underground—a pneumatic) belt slicer 22 is recommended.

FIG. 11d shows a schematic illustration of a method step for forming a multiplicity of notches or furrows 32, which are arranged between the webs 34 each enclosing a steel cable 23. The furrows 32 thus extend in the longitudinal direction of the conveyor belt 1. For this purpose, a knife and/or an electric (or in a critical environment—for example, underground—a pneumatic) belt slicer 22 is preferably recommended.

If the required number of notches or furrows 32 is formed, the belt ends 1a, 1b are aligned with one another in such a way that the abutment edges 31 of both belt ends 1a, 1b abut one another. The belt ends 1a, 1b are then turned over as shown in FIG. 11e, so that the abutting edges rest on a section of the conveyor belt 1 associated with the belt end 1a, 1b. In this position, the belt ends 1a, 1b are fixed and the abutment gap strip 2 is placed on the fixing device. If desired, a textile reinforcement (not shown here) is applied to the abutment gap strip 2.

Surfaces to be bonded are then prepared for bonding, as shown in FIG. 11e. This preferably includes roughening by means of a suitable tool 12 such as, for example, a roughener known from the prior art, a wire brush, or an angle grinder.

Subsequently, as shown in FIG. 11f, the adhesive 7 can be applied to the surfaces of the ends 1a, 1b to be connected to one another of conveyor belts 1 reinforced with steel cable belts 23. For this purpose, the adhesive 7 is applied as quickly as possible to all contact surfaces and then evenly distributed using a suitable tool, for example a spatula or brush 14. A brush 14 is particularly useful, since the adhesive 7 should also be rubbed into the pores. As already mentioned above, the application of the adhesive 7 should take place as quickly as possible, since the surface to have the adhesive 7 applied to it is very large, and the adhesive 7 in the static mixer 13 already begins to cure after a very short time.

The belt ends 1a, 1b are then folded back so that the abutment gap 3 formed on one side between the two belt ends 1a, 1b comes to rest on the abutment gap strip 2 and is bonded to it, as shown in FIG. 11g. For bonding, the belt ends 1a, 1b can be pressed onto the abutment strip 2, for example by means of a roller (not shown here).

Adhesive 7 is now introduced into the notches or furrows 32 and onto the surfaces of the webs 34, for example by means of a cartridge gun 13. The adhesive can be distributed using suitable tools 14 such as a brush or spatula.

Subsequently, as shown schematically in FIG. 11h, the tensile load transmission means 33, such as steel cables, are inserted in such a way that one furrow 32 is preferably arranged in each case and can be bonded to the furrow walls therein. If necessary, adhesive 7 can be squeezed out with a suitable tool 14. If a tensile load transmission means 33 is arranged in each furrow 32, it should be ensured that the surfaces of the webs 34 also have adhesive 7 applied to them, since the top layer 4a is now to be applied thereon, as shown in FIG. 11i. For this purpose, the entire bottom side of the top layer has already had adhesive 7 applied to it. After the top layer 4a has been placed on the furrows 32, tensile load transmission means 33 and webs 34 provided with adhesive and has preferably been pressed on slightly, the lateral protrusion of the protective layer 28 is turned over around the connection point. This means that the connection point can also be protected from the side. It may be advantageous to place a further protective layer between the folded ends of the protective layer 28 in order to cover an intermediate space remaining between the folded ends of the protective layer 28.

Edge rails 29 are now preferably applied laterally to the folded protective layer, as shown in FIG. 11j, in order to also fix the connection point in the width direction. Since—unlike the finger connection—the individual furrows and webs remain continuously connected to each other, this fixation is less critical and usually optional. As described above, the edge rails 29 should have a somewhat lower height than the conveyor belt 1 in order to enable the large-area pressurisation in the vertical direction of the conveyor belt. The edge rails 29 should be pressurised towards one another by means of suitable means 35 (shown in FIG. 11k).

FIG. 11k shows a schematic illustration of a conveyor belt 1 which is fixed for curing the adhesive 7 and reinforced with steel cable belts 23. The edge rails 29 are pressurised in the direction of one another by suitable means 35 (in this case length-adjustable steel cables, but chains, for example with tensioning screws, would also be conceivable). This prevents excessive expansion of the connection point in the width direction when pressure is applied in the height direction. In the vertical direction, the connection point is provided by means of an upper pressure distribution device 10 (here a (possibly pre-stressed) plate), which is pressurised in the vertical direction of the conveyor belt 1 by means of suitable pressurising means 11 (here, for example, screw clamps) relative to a lower pressure distribution device, namely the above-mentioned part of the fixing device. U profiles are used in the example shown to transmit pressure between the pressurising means 11 and the pressure distribution device 10. The U profiles can have bores with adjusting screws 30 arranged therein, which make it possible to adapt the pressure locally and/or to compensate for the deflection of the U-profiles.

In this variant, the adhesive consumption is usually somewhat lower than in the previously described variant according to FIGS. 9a-9g. Since the indentations 32 produced have to be filled in a form-fitting manner next to the tensile load transmission means 33 with only a little adhesive 7, the adhesive requirement is usually in the range from 500 to 1500 g/m², usually in the range from 750 to 1000 g/m². In particular, the adhesive requirement is influenced by the nature of the material (in particular roughness, tightness of the covering fabric, gap width between the groove and tensile load transmission means or steel cable).

In this variant, it has proven to be preferred to use and bond top layers with textile reinforcement 24. This has proven to be advantageous with regard to an increased connection strength with essentially unchanged method expenditure. For a given connection strength, a shorter connection length can be used.

It is advantageous—regardless of the method—to apply the upper and lower top layers 4a, 4b offset in the longitudinal direction in order to ensure a smooth transition.

In individual cases, it must be checked whether the alternative described above does not become too stiff due to the additionally inserted tensile load transmission means for the drum of the conveyor system.

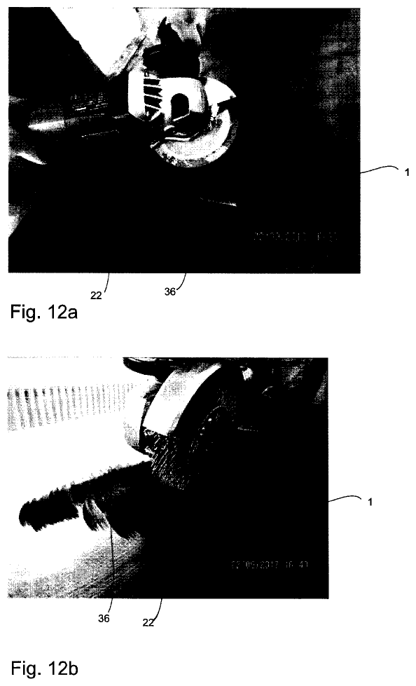

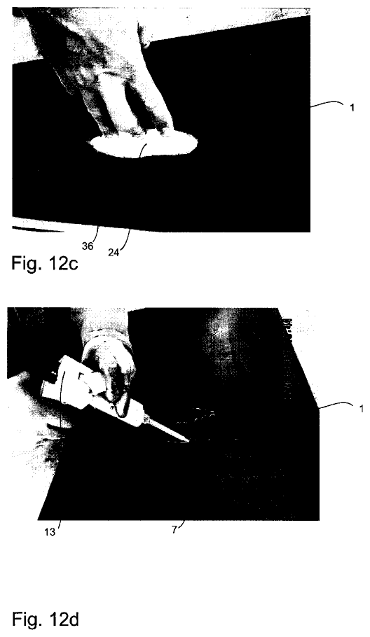

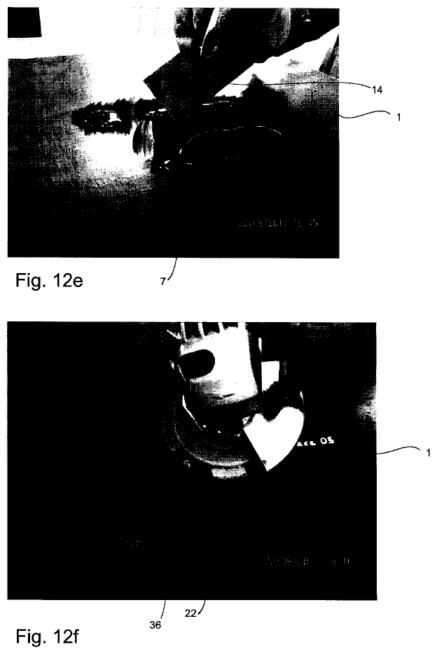

Another advantage of the adhesive described above is that it can also be used to repair damaged areas in permanently elastic plastic surfaces. FIGS. 12a-12f show an example of how such a damage location can be remedied.

FIG. 12a shows a plan view of a damaged area 36 of a conveyor belt 1 while chamfering the damaged area edges in preparation for their repair. Damaged areas 36 in a conveyor belt 1 occur comparatively frequently. The cause can be, for example, angular goods that fall onto the conveyor belt 1 and damage it with an edge. A comparatively small instance of damage is shown in FIG. 12a. Such damage often extends in the longitudinal direction of the conveyor belt 1, since an object penetrating the conveyor belt 1 can get caught in other components of the transport system and become held there. If the conveyor belt 1 is then operated further, such an object literally cuts the conveyor belt 1 in the longitudinal direction. Depending on the time between the creation of the damaged area 36 and the complete standstill of the conveyor belt 1, the conveyor belt 1—depending on the transport speed, the degree of loading, the weight of the transported goods, the reaction time until the damage is recognised, and other factors—can already be several meters, often even a few hundred meters. Correspondingly, tears with an extension of up to 500 meters in the longitudinal direction of the belt can arise. If such a damaged area 36 had to be replaced, this would involve enormous effort and costs. Especially when used in a difficult to access environment, the effort is enormous, and the result is a loss of use lasting several days.

Experiments with the adhesive 7 described above, however, have shown that such damaged areas can be filled with this adhesive 7.

As shown in FIG. 12a, in order to repair a damaged area 36, the subsequent contact surfaces are initially prepared with the adhesive. For this purpose, the contact area is enlarged by chamfering the edges of the damaged area. It has proven to be preferred to chamfer the edges of the damaged area at an angle of more than 30°. This could be done (for example, as shown in FIG. 12a) using a suitable tool 22, such as an angle grinder or a knife.

The surface should then be ground off (for example as shown in FIG. 12b) in order to achieve an improved adhesion of the adhesive 7. If, as shown in FIG. 12b, a suitable tool 12 such as a grinding wheel (e.g., K16) is used, this should be operated at a low number of revolutions, for example 800 RPM or less. The preferred low number of revolutions prevents or at least reduces damage to the permanently elastic plastic, for example burning of the rubber. The edges of the damaged area 36 should then be roughened, as a result of which the adhesion of the adhesive can be further improved. This could be done, for example, using a round metal brush or a roughening brush. Roughening should take place transversely to the direction of transport in order to achieve the best possible bond. Subsequently, abrasion and other dirt must be removed, for example using a brush, compressed air, or other suitable means 14. At temperatures below the dew point, the contact surfaces should be dried with an absorbent paper and warmed up slightly. A hot air application device has proven to be suitable. Heating above 60° C. should be avoided in order not to damage the conveyor belt and to ensure that the adhesive 7 can be processed.

As shown in FIG. 12c, textile reinforcement 24 should be inserted in the case of extensive damaged areas 36. Textile reinforcement 24 should be inserted in particular in the case of holes and cracks wider than 1 cm or longer than 10 cm. For this purpose, it is advantageous to uncover a few centimeters of the casing around the damaged area 36 and then to glue in the textile reinforcement 24 in order to achieve sufficient strength.

Continuous tears and holes should first be bridged on one side of the belt with an adhesive tape (not shown). This forms an area closed on three sides, which can be filled with adhesive 7 and, possibly, additional filler material.

FIG. 12d shows a view of a damaged area of a conveyor belt 1 while the adhesive 7 is being introduced into the damaged area. The adhesive 7 can now be introduced into the damaged area 36 prepared as described above. The use of a cartridge gun 13 has proven to be preferred. In the case of smaller damaged areas 36 in particular, the first drops of the adhesive 7 pressed out by the cartridge gun 13 should be discarded, since there may not be sufficiently mixed components in these first drops. The adhesive 7 should be applied within a few minutes and rubbed into the pores 14 in order to achieve good adhesion immediately afterwards, preferably with a short-bristled brush. Additional adhesive 7 should, for example, be smoothed using a spatula 14 (see FIG. 12e).

Then the adhesive 7 is cured. This can be done under ambient conditions or at an elevated temperature. The time until the adhesive 7 has completely cured is temperature-dependent and, in the case of an exemplary adhesive composition, is approximately 60 minutes at 23° C. With a suitable hot air application device, curing could be reduced to less than 30 minutes, although it should be noted that at temperatures >80° C., damage to the belt 1 or adhesive 7 can occur.

When the adhesive 7 has cured, the repaired area can be reworked. FIG. 12f shows a plan view of a repaired damaged area 36 of a conveyor belt 1 during mechanical reworking. For reworking, the repaired damaged area 36 can be ground off using a suitable tool 22. The belt 1 can then be used again. Smaller damaged areas 36 in particular can thus be repaired in less than an hour.

The relationship between curing to full functional strength of the belt connection and temperature is shown in FIG. 13. As can be seen in the diagram, this time depends on the adhesive used and the temperature. The diagram shows the relationship between two different adhesives, namely “adhesive 20” and “adhesive 40”. Exemplary connections are shown from a conveyor belt reinforced with steel cord belts with a thickness of 20 mm. With ambient conditions of, for example, 23° C., a curing time of at least 8 hours is recommended for “adhesive 20”. With “adhesive 40”, the curing time should be at least 18 hours.

As can also be seen in the diagram, the curing time can be adapted to the respective requirements if the temperature is appropriately adjusted. For example, if a suitable heating source (e.g., a heating mat, an IR lamp, a heating plate, a vulcanising press, or other means) is used, the curing time could be reduced to less than 4 hours. Considering that conventional materials for conveyor belts can withstand temperatures of up to 80° C. for a long period of time without damage, a curing time of less than 2 hours could be achieved when this temperature is selected for curing the adhesive, which means a significant reduction compared to those methods previously used to connect conveyor belt ends, and thus also means a cost savings and fewer losses due to reduced downtime.

Not all of the described features and properties have to be shown in all drawings and/or provided with reference numerals. The same or similar devices, equipment or features can be provided with the same reference numerals, provided that they fulfil the same or similar tasks.

The applicant reserves the right to claim all the features disclosed in the application documents as essential to the invention, provided that these are novel individually or in combination with respect to the prior art.

### LIST OF REFERENCE SIGNS

1: conveyor belt,
1a, 1b end of conveyor belt,
2, 2a, 2b (abutment gap) strips,
3a, 3b abutment gap,
4, 4a, 4b, 4c, 4d: top layer,
5a, 5b, 5c: step,
6a, 6b: sides of the conveyor belt,
7: adhesive,
8a, 8b, 8c, 8d: layer/level,
L: longitudinal direction of the conveyor belt,
B: width direction of the conveyor belt,
9: base,
10: pressurisation device/screw clamp,
11: pressure distribution device
12: tool/wire brush/roughener/angle grinder,
13: cartridge gun,
14: tool/spatula/brush,
15: pressure roller/wheel,
16: (metal) drum,
17: (rubber) sheathing/covering,
18: adhesive surface,
19, 19a, 19b, 19c: cutting edge,
20: (drum) longitudinal axis
21: overlapping portion/protruding edge,
22: tool/knife/saw/angle grinder,
23: reinforcement/steel cable belt,
24: textile reinforcement 24,
25: surrounding material/rubber material,
26, 26a-c, 26n-q: fingers,
27: finger pair,
28: protective layer,
29: edge rail;
30: adjusting screw,
31: abutment edge,
32: notch,
33: tensile load transmission means/steel cable,
34: web,
35: (pressurising) medium/variable length steel cable/chain,
36: damaged area

What is claimed is:

1. A method for high-strength and permanently elastic bonding of at least two surfaces to one another, of which at least one surface is a surface of a permanently elastic plastic, by means of an adhesive, said method comprising the steps of:
a) applying the adhesive to at least a first of the surfaces to be connected,
b) ensuring conditions under which at least a first hardening mechanism of the adhesive can take place, said mechanism comprising at least a chemical reaction with the formation of a chemical bond including at least one sulphur atom,
c) bringing the first surface provided with the adhesive into contact with the second surface optionally also provided with the adhesive, and
d) ensuring conditions under which at least a second hardening mechanism of the adhesive can take place, said mechanism comprising at least the formation of crystalline structures from amorphous polymers.

2. The method according to claim 1, wherein the adhesive comprises less than 5 wt. % of solvent.

3. The method according to claim 1, wherein the adhesive comprises two components.

4. The method according to claim 1, wherein the adhesive is applied to the surface to be bonded in an amount less than or equal to 500 grams per square meter (g/m²).

5. The method according to claim 1, wherein at least the surface comprising a permanently elastic plastic is cleaned and roughened before step a).

6. The method according to claim 1, wherein the surfaces to be bonded are fixed with respect to one another after step d) by means of a suitable fixing device.

7. The method according to claim 1, wherein the surfaces to be bonded are parts of a permanently elastic plastic belt, wherein the surfaces to be bonded are opposite ends of the permanently elastic plastic belt, which are joined together to form an endless belt.

8-15. (canceled)

16. The method according to claim 1, wherein the adhesive comprises less than 3 wt. % of solvent.

17. The method according to claim 1, wherein the adhesive is solvent-free.

18. The method according to claim 1, wherein a minimum time interval between steps b) and c) necessary for the evaporation of solvent at an ambient temperature between 20° C. and 25° C. is less than 3 hours.

19. The method according to claim 1, wherein a minimum time interval between steps b) and c) necessary for the evaporation of solvent at an ambient temperature between 20° C. and 25° C. is less than 3 hours.

20. The method according to claim 3, wherein the two-component adhesive is provided in a double cartridge.

21. The method according to claim 3, wherein the two-component adhesive is applied to the surface to be bonded by means of a compatible cartridge gun.

22. The method according to claim 1, wherein the adhesive is applied to the surface to be bonded in an amount of less than or equal to 200 grams per square meter (g/m²).

23. The method according to claim 1, wherein the adhesive is applied to the surface to be bonded in an amount of less than or equal to 100 grams per square meter (g/m²).

24. The method according to claim 5, wherein the surface comprising the permanently elastic plastic is cleaned and roughened before step a) using a tool selected from a group comprising rougheners, angle grinders, planers, brushes, grinding belts, grinding wheels, and milling cutters.

25. The method according to claim 1, wherein both surfaces to be bonded are cleaned and roughened before step a).

26. The method according to claim 1, wherein the surfaces to be bonded are pressurized with respect to one another after step d) by means of a suitable pressurizing device.

27. The method according to claim 1, wherein the surfaces to be bonded are pressurized with respect to one another after step d) by means of a pressurizing device, wherein the pressurizing device comprises at least one pressure element and pressure distribution elements, wherein the pressure distribution elements distribute the pressure generated by the at least one pressure element over an area that comprises a bonding area.

28. The method according to claim 1, wherein the surfaces to be bonded are parts of a rubber belt, wherein the surfaces to be bonded are opposite ends of the rubber belt that are joined together to form an endless belt.
